(19) United States
(12) Patent Application Publication
(10) Pub. No.: US 2020/0118166 A1
(43) Pub. Date: Apr. 16, 2020

(54) MODIFIABLE DISPLAY DEVICES AND SYSTEMS

(71) Applicant: PlayForm, Inc., Diamond Bar, CA (US)

(72) Inventors: John Miller, Santa Monica, CA (US); Quest Miller, Santa Monica, CA (US); Violet Miller, Santa Monica, CA (US)

(21) Appl. No.: 16/705,957

(22) Filed: Dec. 6, 2019

Related U.S. Application Data
(63) Continuation of application No. 15/454,655, filed on Mar. 9, 2017.
(60) Provisional application No. 62/305,745, filed on Mar. 9, 2016.
(60) Provisional application No. 62/468,711, filed on Mar. 8, 2017.

(51) Int. Cl. G06Q 30/02; G06F 1/26; A45F 3/04; A43B 3/00; A42B 1/24; A42B 1/00; A41D 25/00; A41D 1/04; A41D 1/00; G06F 3/147; A45C 15/00

(52) U.S. Cl. CPC G06Q 30/0255; G06Q 30/0267; G06F 1/26; A45F 3/04; A43B 3/0005; A42B 1/24; A45F 2003/001; A41D 25/00; A41D 1/04; A41D 1/002; G06F 3/147; A45C 15/00; A42B 1/004

(57) ABSTRACT

A backpack having a modifiable display. The backpack may include an active element arranged on an outer surface of the backpack, a power supply arranged on the backpack, and a controller arranged on the backpack and in electrical communication with the power supply and the active element. In some embodiments, the active element may include one or more drivers. The one or more drivers may be coated in a sealant, such as a rubber sealant. The active element may be a flexible display configured to display, such as an LED, LCD, OLED, AM-OLED, or EPD display. In some embodiments, the backpack may be part of a self-expression kit, and the modifiable display may be removable and configured for coupling to other surfaces. In some embodiments, the backpack may be part of an advertising network having a plurality of wearable articles and a digital marketplace for advertising opportunities.

### CROSS-REFERENCE TO RELATED APPLICATIONS

The present application claims priority to U.S. Provisional Patent Application No. 62/305,745, filed on Mar. 9, 2016, entitled Modifiable Display Devices and system, the content of which is hereby incorporated by reference herein in its entirety. The present application additionally claims the benefit of Provisional Patent Application No. 62/468,711, filed Mar. 8, 2016, entitled Offline Wearable Display and Advertising Network with Data Gathering, the content of which is hereby incorporated herein in its entirety.

### FIELD OF THE INVENTION

The present application is generally directed to electronic modifiable displays. Particularly, the present disclosure relates to electronic modifiable displays that may be flexible and formable into one of several positions. More particularly, the present disclosure relates to self-expression through wearable articles having modifiable displays.

### BACKGROUND OF THE INVENTION

Items and articles we wear and/or use day-to-day are typically of a particular design. For example, clothing typically involves a particular design including the way that it fits and the colors and designs it includes on an outer surface. These designs, once established, are commonly static and do not provide the owner or user of the articles the flexibility to adjust the design. Accordingly, to obtain such flexibility, users may purchase and/or own multiple types of clothing, accessories, or other articles outside of clothing each having various designs.

Recently, a variety of new technologies have emerged that enable flexible displays. Flexible displays include (but are not limited to) liquid crystal displays (LCD), organic light emitting diode (OLED), and electrophoretic displays (EPD, also known as “E-Paper”). For example, Samsung Electronics has demonstrated color AM-OLED displays that are flexible. These displays have been implemented in common electrical formats including mobile devices and wrist watches, for example.

Displays, which may be static or dynamic, are often used in advertising. Digital display advertisements are typically rigid displays attached to walls or other structures in public places, such as airports and shopping malls. These displays are typically expensive to procure, install, and operate. Additionally, advertisers generally do not receive immediate feedback from such advertisements, relying instead on survey responses and/or sales. Another type of advertising is sponsorships, such as with athletes or other high profile individuals. For example, a company may pay an athlete to wear and/or promote a particular item or brand in order to advertise for the company. Such high profile sponsorships may be expensive and generally limit exposure to those who like or follow the particular athlete or other sponsored individual.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a backpack having a modifiable display. The backpack may include an active element arranged on an outer surface of the backpack, a power supply arranged on the backpack, and a controller arranged on the backpack and in electrical communication with the power supply and the active element. In some embodiments, the active element may include one or more drivers. The one or more drivers may be coated in a sealant, such as a rubber sealant. The active element may be a flexible display configured to display a color, an image, and/or a video. In some embodiments, the active element may include at least one of an LED, LCD, OLED, AM-OLED, and an EPD display. The power supply and controller may be arranged within a pocket of the backpack. Additionally, the power supply may be configured to be rechargeable in some embodiments, and may have a charging port.

The present disclosure, in one or more embodiments, additionally relates to a self-expression kit. The self-expression kit may include a wearable article, a modifiable display configured to be removably coupled to the wearable article, a sleeve for receiving the modifiable display, first attachment means for removably coupling the modifiable display to the wearable article, and second attachment means for removably coupling the modifiable display to a surface. In some embodiments, the wearable article may be a backpack. In other embodiments, the wearable article may be a handbag. The sleeve may be fixed to the wearable article in some embodiments. Further, the modifiable display may be a flexible display. The first or second attachment means may include Velcro and/or a magnet.

The present disclosure, in one or more embodiments, additionally relates to an advertising network having a plurality of articles and a digital marketplace. The plurality of articles may each have a modifiable display and may be associated with a user. The digital marketplace may be for advertising opportunities and a user may have the ability to agree to display advertising content on his or her associated modifiable display. The digital marketplace may include a plurality of sponsorship offers from advertisers in some embodiments. In other embodiments, the digital marketplace may include a plurality of sponsorship requests from users. One or more of the plurality of articles may be a wearable article, such as a backpack.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures.

FIG. 1 shows a perspective view of a backpack having a modifiable display, according to one or more embodiments.

FIG. 2 shows a front view of an active element of the backpack of FIG. 1, according to one or more embodiments.

FIG. 3A shows a schematic diagram of a circuit of the backpack of FIG. 1, according to one or more embodiments.

FIG. 3B shows a circuit of a modifiable display article, according to one or more embodiments.

FIG. 4A shows another backpack having a modifiable display, according to one or more embodiments.

FIG. 4B shows another backpack having a modifiable display, according to one or more embodiments.

FIG. 4C shows another backpack having a modifiable display, according to one or more embodiments.

FIG. 4D shows another backpack having a modifiable display, according to one or more embodiments.

FIG. 4E shows another backpack having a modifiable display, according to one or more embodiments.

FIG. 4F shows another backpack having a modifiable display, according to one or more embodiments.

FIG. 4G shows another backpack having a modifiable display, according to one or more embodiments.

FIG. 4H shows another backpack having a modifiable display, according to one or more embodiments.

FIG. 4I shows another backpack having a modifiable display, according to one or more embodiments.

FIG. 4J shows another backpack having a modifiable display, according to one or more embodiments.

FIG. 4K shows another backpack having a modifiable display, according to one or more embodiments.

FIG. 4L shows another backpack having a modifiable display, according to one or more embodiments.

FIG. 4M shows the backpack of FIG. 4L being subjected to a high temperature environment, according to one or more embodiments.

FIG. 4N shows the backpack of FIG. 4L being subjected to a low temperature environment, according to one or more embodiments.

FIG. 5 shows a perspective view of a handbag having a modifiable display, according to one or more embodiments.

FIG. 6A shows another handbag having a modifiable display, according to one or more embodiments.

FIG. 6B shows another handbag having a modifiable display, according to one or more embodiments.

FIG. 6C shows another handbag having a modifiable display, according to one or more embodiments.

FIG. 6D shows another handbag having a modifiable display, according to one or more embodiments.

FIG. 6E shows another handbag having a modifiable display, according to one or more embodiments.

FIG. 7A shows a front view of a tie having a modifiable display, according to one or more embodiments.

FIG. 7B shows a front view of another tie having a modifiable display, according to one or more embodiments.

FIG. 8 shows a front view of a sweatshirt having a modifiable display, according to one or more embodiments.

FIG. 9 shows a perspective view of a cap having a modifiable display, according to one or more embodiments.

FIG. 10 shows a perspective view of a shoe having a modifiable display, according to one or more embodiments.

FIG. 11A shows a top view of a sandal having a modifiable display, according to one or more embodiments.

FIG. 11B shows a side view of the sandal of FIG. 11A, according to one or more embodiments.

FIG. 11C shows a side view of another sandal having a modifiable display, according to one or more embodiments.

FIG. 12 shows a side view of a boot having a modifiable display, according to one or more embodiments.

FIG. 13A shows a wallet having a modifiable display, according to one or more embodiments.

FIG. 13B shows another wallet having a modifiable display, according to one or more embodiments.

FIG. 13C shows another wallet having a modifiable display, according to one or more embodiments.

FIG. 14A shows a side view of a belt having a modifiable display, according to one or more embodiments.

FIG. 14B shows a front view of the belt of FIG. 14A, according to one or more embodiments.

FIG. 15 shows a perspective view of a notebook having a modifiable display, according to one or more embodiments.

FIG. 16 shows a bicycle decoration having a modifiable display, according to one or more embodiments.

FIG. 17A shows a molded product, in the form of a cup, having a modifiable display, according to one or more embodiments.

FIG. 17B shows a molded product, in the form of a plate, having a modifiable display, according to one or more embodiments.

FIG. 18 is a method of displaying advertising content to consumers, according to one or more embodiments.

FIG. 19 is another method of displaying advertising content to consumers, according to one or more embodiments.

FIG. 20A shows an example of an interface for a smartphone application of the present disclosure, according to one or more embodiments.

FIG. 20B shows another example of an interface for a smartphone application of the present disclosure, according to one or more embodiments.

FIG. 20C shows another example of an interface for a smartphone application of the present disclosure, according to one or more embodiments.

FIG. 20D shows another example of an interface for a smartphone application of the present disclosure, according to one or more embodiments.

FIG. 20E shows another example of an interface for a smartphone application of the present disclosure, according to one or more embodiments.

FIG. 20F shows another example of an interface for a smartphone application of the present disclosure, according to one or more embodiments.

FIG. 20G shows another example of an interface for a smartphone application of the present disclosure, according to one or more embodiments.

### DETAILED DESCRIPTION

The present disclosure, in some embodiments, relates to articles incorporating controllable or modifiable displays and/or elements. Articles of the present disclosure having modifiable displays may include, for example, wearable items such as backpacks, handbags, satchels, footwear, or clothing. Articles of the present disclosure having modifiable displays may additionally include journals or other books or book covers, accessories, household items, useful items, toys, decorations, or other articles. An article of the present disclosure may include controllable displays and/or elements such that the article's appearance is not static, but is instead dynamic and/or adjustable. For example, in some embodiments, the article may be adjusted to display a particular color and/or to show various types of static or dynamic content. In some embodiments, the article may be adjusted to display an advertisement, promotional material, and/or content related to a particular product, brand, or company In some particular cases, for example, an article, such as a backpack or other wearable article, may be adapted such that a user may display an advertisement for NIKE or another brand or company for a period of time. By wearing or carrying the backpack, the user may effectively display the advertisement to the user's friends and/or others who may come in proximity to the user. The present disclosure additionally relates to a network for sponsorship advertising, wherein companies or brand owners may connect with wearable display users for sponsorship opportunities. As one particular example, a company such as NIKE may use the sponsorship network to offer a sponsorship opportunity to a particular backpack owner, wherein the backpack owner may be compensated for displaying a NIKE advertisement for a period of time on the user's backpack display. In some embodiments, one or more audio and/or visual recording devices may be arranged within or coupled to the article. For example, a camera may be incorporated into a display on a backpack to record photographs and/or video of individuals who view the display. Such audio and/or visual devices may provide data to advertisers, companies, or brand owners regarding public reactions to an advertisement or other material displayed on a wearable display. In some embodiments, facial recognition or other technologies used in conjunction with such audio and/or visual recording may allow advertisers, companies, or brand owners to further provide targeted advertising to individuals based on their recorded response to the advertisement or other material displayed on the backpack.

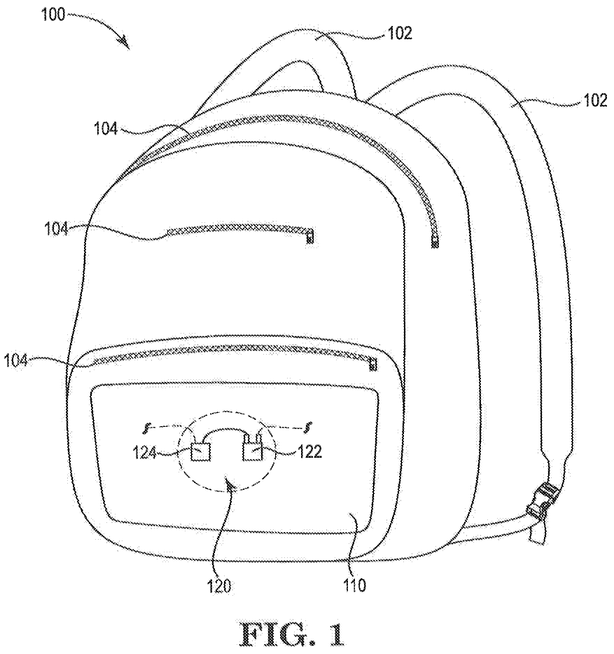

Turning to FIG. 1, an example of a backpack 100 of the present disclosure is shown. The backpack 100 may generally be constructed of canvas, leather, nylon, neoprene, or other materials. The backpack 100 may have one or more carrying straps 102 and one or more storage pockets 104. In some embodiments, the backpack 100 may have a spine portion configured to provide structure to at least a portion of the backpack. The backpack 100 may have an active element 110 positioned on or integrated with the backpack, and a circuit 120 configured to power the active element.

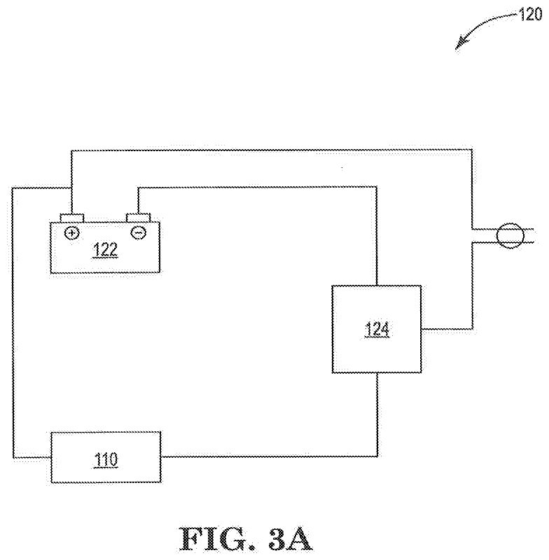

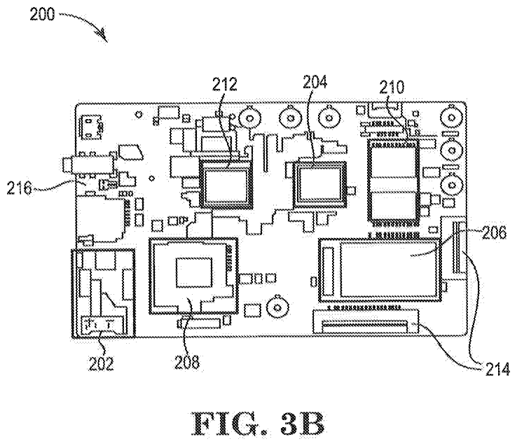

The active element 110 may be configured to display one or more colors, designs, images, series of images, videos, and/or other elements. The active element 110 may be configured to display a dynamic display in some embodiments. The active element 110 may be positioned on or incorporated in a portion or the backpack 100 or the entire outer surface of the backpack, for example. For example, as shown in FIG. 1, the active element 110 may be positioned over an outer pocket or other portion of the backpack 100 such that it may be visible to observers while the backpack is positioned on a user's back. The active element 110 may generally have any suitable shape. As shown in FIG. 1, for example, the active element 110 may have a square or rectangular shape. In other embodiments, the active element 110 may have round, triangular, or generally any other shape. The active element 110 may have any suitable size. For example, the active element 110 may have a height and width of between 1 and 20 inches in some embodiments. In at least one embodiment, for example, the active element 110 may have a height and width of between approximately 3 and approximately 6 inches. In another embodiment, the active element 110 may have a height of between approximately 12 and approximately 17 inches and a width of between approximately 8 and approximately 12 inches. The active element 110 may have other dimensions in other embodiments. In still further embodiments, the active element 110 may be an entire surface of the backpack 100, so as to cover an entire outer or visible surface, for example. FIG. 3 illustrates an example of the active element 110, according to some embodiments. The active element 110 may have a display screen 112 configured to display content and one or more display drivers 114a, 114b configured to power the display screen.

The display screen 112 may be or include one or more displays such as an LED, LCD, OLED, AM-OLED, EPD, or other modifiable display. EPD displays operate by using surrounding light and rearranging charged pigment particles using an applied electric field. EPD displays can hold static text and images indefinitely without using electricity. EPD displays have been shown to be flexible. For example, Samsung and Unidyin demonstrated 14 inch color, flexible EPD displays. EPD displays can be either passive matrix or active matrix. Passive matrix displays do not have a TFT backplane and are generally lower resolution than active matrix displays. Active matrix displays have a TFT backplane. Active matrix EPD displays can be made flexible using flexible backplanes. OLED displays use an emissive electroluminescent layer sandwiched between two electrodes to emit light in response to an electric current. In some embodiments, the active display screen 112 may be or include a color changing conductor configured to change colors depending on the voltage applied to its surface. The display screen 112 may be a flexible display in some embodiments. For example, printable organic materials (such as polymers and small molecules) and inorganic materials (such as carbon nanotubes, metal nanowires, and semiconductor nanowires) can be used to fabricate an active layer (e g. OLED layer), transparent conducting layers, and thin film transistors, for example. In this way, it may be appreciated that the active element 110 may be bendable, foldable, and/or stretchable without impairing the electronic functionality or visual display of the backpack 100. In some embodiments, a coating, film, or other flexible, transparent material may be positioned over the display screen 112 so as to protect the active element from scratches, water damage or other damage. Such material may additionally or alternatively provide for an anti-reflective surface.

The one or more drivers 114a, 114b may include electronics necessary for operating the display screen 112. The one or more drivers 114a, 114b may additionally operate to couple the active element 110 to a source, such as the circuit 120, via one or more cables or other connectors. The drivers 114a, 114b may be constructed partially or entirely of flexible materials in some embodiments. In some embodiments, the drivers 114a, 114b may be configured to fold behind the display screen 112, such that the drivers may be concealed while the active element 110 is in use. In some embodiments, a seal such as a hermetic seal, coating, film, or other protective covering may be positioned over or around the drivers 114a, 114b. For example, the drivers 114a, 114b may be covered or positioned in a rubber seal or coating. Such rubber seal or other protective covering may protect the drivers 114a, 114b from damage and/or moisture or other contaminants. Moreover, the rubber seal or other covering may be coupled directly to the backpack 100 via sewing or other means.

The circuit 120 may be generally configured to power to active element 110. The circuit 120 may be positioned on, coupled to, or otherwise integrated with the backpack 100 in various ways. For example, in some embodiments, the circuit 120 may be positioned in a pocket of the backpack 100. In other embodiments, the circuit 120 may be sewn into the backpack 100, such as into a seam for example. In some embodiments, the circuit 120 or a portion or element(s) thereof may be removable and/or replaceable. The circuit 120 may be rigid or flexible, and each element of the circuit may include a wide range of sophistication depending on the desired ability of adjustment. FIG. 3A illustrates a schematic diagram of the circuit 120. The circuit 120 may have a power supply 122 and a controller 124.

The power supply 122 may be configured to power the dynamic or otherwise modifiable appearance of the article. The power supply 122 may include one or more available or later developed batteries or energy storing technologies. The batteries may be of different types. In some embodiments, the power supply 122 may include a thin film lithium ion battery. In some embodiments, one or more batteries may be rechargeable. In some embodiments, the circuit 120 may include means for charging the power supply 122. For example, the circuit 120 may include a USB, micro USB, or other port for connecting a power source to charge the power supply 122. In other embodiments, the power supply 122 may be charged by other means, including remote or wireless charging means such as magnetic charging. In some embodiments, the charging circuit to recharge the power supply 122 may run through the controller 124, allowing the controller to monitor and/or control charging. In some embodiments, the power supply 122 may be replaceable and a battery replacement area that may include an access panel may be provided for removing and/or replacing the power supply. It is to be appreciated that while a lithium ion battery has been discussed, still other types and numbers of batteries may be provided depending on the needs of the system, the battery life desired, and the continually developing battery technologies. For example, in some embodiments, advanced materials may be used for thin-film batteries. In some embodiments, the battery used may be coordinated with the needs of the system, which may depend on the amount and speed of the changing content on the modifiable display, the brightness and amount of use of the display, and the overall amount of draw the display may put on the battery. In some embodiments, a relatively small draw may be provided by using displays that do not require a backlight, for example organic LED, or using electrophoretic displays that are reflective and use light from surroundings to project images.

The controller 124 may include a switch, a resistance adjustment, or a circuit in some embodiments. In some embodiments, the controller 124 may include a computing device such as a processor or a central processing unit (CPU) capable of receiving data and/or performing instructions. Such instructions may be programmed or programmable into the controller 124. In some embodiments, the controller 124 may have one or more memory devices, such as solid state drive (SSD) and/or hard disk drive (HDD) devices. The one or more memory device may be capable of receiving and storing data. The controller 124 may be arranged on or within the backpack 100 at any suitable location. In some embodiments, the controller 124 and/or any other component(s) of the circuit 120, may be arranged on or in the backpack 100 near or adjacent to a back surface. In this way, the controller 124 may be arranged such that the controller may be near or adjacent a user's back or spine while wearing the backpack. In other embodiments, the controller 124, and/or any other component(s) of the circuit 120, may be arranged at any suitable location.

Depending, in part, on the sophistication of the active element and on other factors, the controller 124 may take one of several varying forms. For example, where the active element 110 is a conductor adapted to change colors depending on the voltage applied to its surface, the controller 124 may be a variable resistor, for example, that controls the amount of voltage applied to the conductor in the circuit. The variable resistor may be in the form of a rheostat, for example, or other element to control the circuit voltage and, thus, the color of the conductor. In this way, a slide or dial mechanism may be positioned on the backpack 100 to provide for adjustment of the voltage.

However, where more control and image detail is desired, a more sophisticated active element 110 may be provided in the form of an electronic display. In this embodiment, the controller 124 may include a circuit, chip, or microcontroller that may be used to control display and provide content for the display. In some embodiments, the controller 124 programmable and/or reprogrammable. A reprogrammable controller 124, for example, may allow a user to adjust the content displayed. Accordingly, the controller 124 may include a computer readable storage medium that may be adjusted and/or modified to store data. The data may include instructions performable by a processor to control the content of the display. The controller 124 may also include inputs and outputs for communicating with external devices for purposes of updating the data stored in the computer readable storage medium. For example, the controller 124 may include wired or wireless communication inputs/outputs adapted for one or more different communication protocols including WiFi, Bluetooth, near field communication, and/or other wireless communication systems and protocols. In this way, a computer, smartphone, tablet, or other device may be used to input data or instructions to the controller 124 via wired or wireless communication.

In some embodiments, application software may be provided allowing a user to download designs from a source of designs provided by the software or from third parties and upload those designs to the controller 124 for display on the active element. In some embodiments, the designs may include stationary messages or the designs may include moving and/or changing messages. In other embodiments no messages or verbal content may be included. In some embodiments, the application software may be available as an app for a smartphone or tablet, for example. The app may allow the user to select from a variety of designs and the app may be configured to communicate with the backpack 100 to adjust, program, or otherwise control the active element 110.

It may be appreciated that other configurations of the circuit 120 may be provided depending on desired sophistication and/or adaptation of the particular article for which the circuit is provided. The circuit 120 may include other or additional components in some embodiments.

It may further be appreciated that the circuit 120 or portions thereof may be generally flexible. For example, various advanced materials can be used to make flexible circuitry and thin film batteries. In this way, the circuit 120 or portions thereof may be generally bendable, foldable, and/or stretchable without impairing the electronic functionality or visual display of the backpack 100.

Another embodiment of a circuit 200 is shown in FIG. 3B. The circuit 200 may be incorporated into or otherwise used with an article of the present disclosure, and used to power and/or control a modifiable display of the article. In some embodiments, the circuit 200 may be used with or incorporated in the backpack 100, for example, to control the active element 110. The circuit 200 may have a power supply 202, a processor 204, a power management integrated circuit (PMIC) 206, a central processing unit (CPU) 208, a random access memory (RAM) device 210, and a flash memory device 212. In some embodiments, the circuit 200 may additionally have one or more ports 214 for coupling to a modifiable display. In other embodiments, the circuit 200 may have more, fewer, or different components.

The power supply 202 may be configured to power the circuit 200 and/or an active element coupled to the circuit, such as a modifiable display. The power supply 202 may be similar to the power supply 122 described above with respect to FIG. 1. For example, the power supply 202 may include one or more available or later developed batteries or energy storing technologies. The power supply 202 may be rechargeable in some embodiments. In such case, the circuit 200 may include means for charging the power supply 202. In some embodiments, the power supply 202 may be removable and/or replaceable. In some embodiments, the power supply 202 may be constructed of one or more flexible materials.

The processor 204 may provide processing power to one or more components of the circuit 200. The processor 204 may be or include any available or later developed processor types. In some embodiments, for example, the processor 204 may be a single or multicore processor. The processor 204 may provide primary processing for the circuit 200 in some embodiments. Additionally or alternatively, the processor 204 may provide processing power for graphics or other elements.

The PMIC 206 may be configured to manage power requirements for an active element coupled to the circuit 200, such as a modifiable display. In this way, the PMIC may regulate power between the power supply 202 and active element. In other embodiments, other power management or power regulating devices or systems may be used.

The CPU 208 may be configured to provide processing power to one or more components of the circuit 200. The CPU 208 may be or include any available or later developed CPU types. The CPU 208 may provide primary processing for the circuit 200 in some embodiments. Additionally or alternatively, the CPU 208 may provide processing power for graphics or other elements.

As mentioned above, the circuit 200 may have one or more memory devices. Each of the RAM device 210 and flash memory device 212 may store data, such as data related to an active element coupled to the circuit 200. For example, either or both memory devices 210, 212 may store instructions for modifying a modifiable display. Either or both memory devices 210, 212 may store other data as well.

Ports 214 may be configured to electrically couple the circuit 200 to an active element, such as a modifiable display. The ports 214 may be any suitable type of connector, such as pin connectors for example.

Each of the elements of the circuit 200 may be positioned on a printed circuit board 216 in some embodiments. In some embodiments, the printed circuit board 216 may be constructed of or include one or more flexible materials. Additionally, it may be appreciated that any of the circuit 200 components may be constructed of or include one or more flexible materials. Moreover, the circuit 200, including the circuit board 216, may have any suitable size. In some embodiments, the circuit 200 may be relatively small. For example, the circuit 200 may have a length and width of between 10 and 200 millimeters in some embodiments. Particularly, the circuit 200 may have a length and width 30 and 120 millimeters in some embodiments. In some embodiments, the circuit 200 may have a thickness of between 1 and 50 millimeters. Particularly, the circuit may have a thickness of between 10 and 30 millimeters in some embodiments.

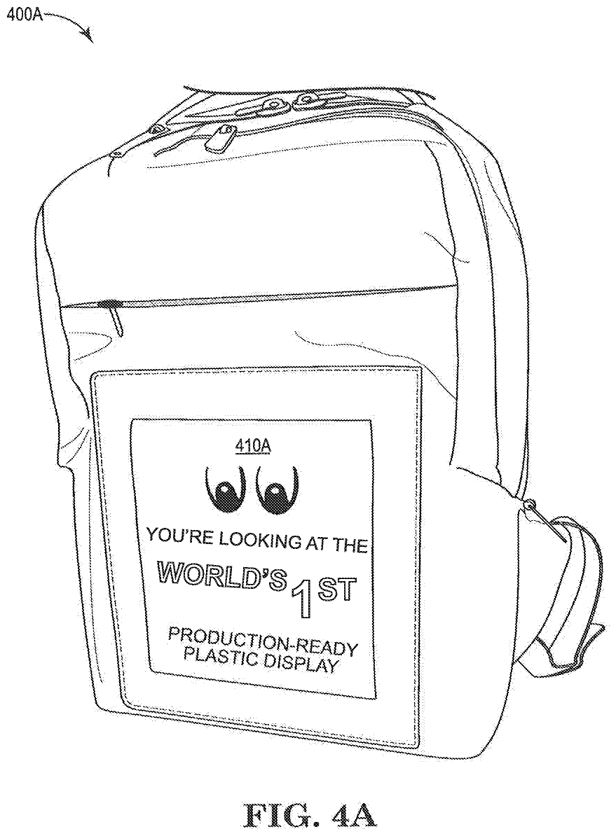

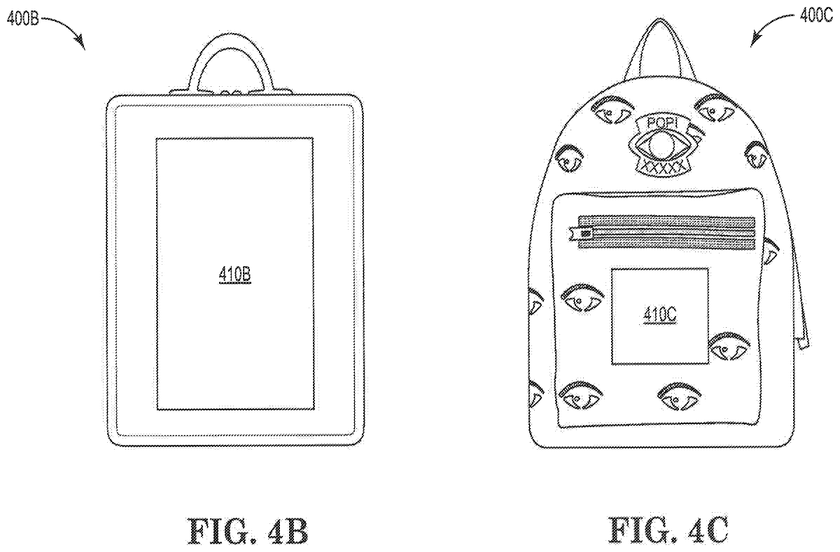

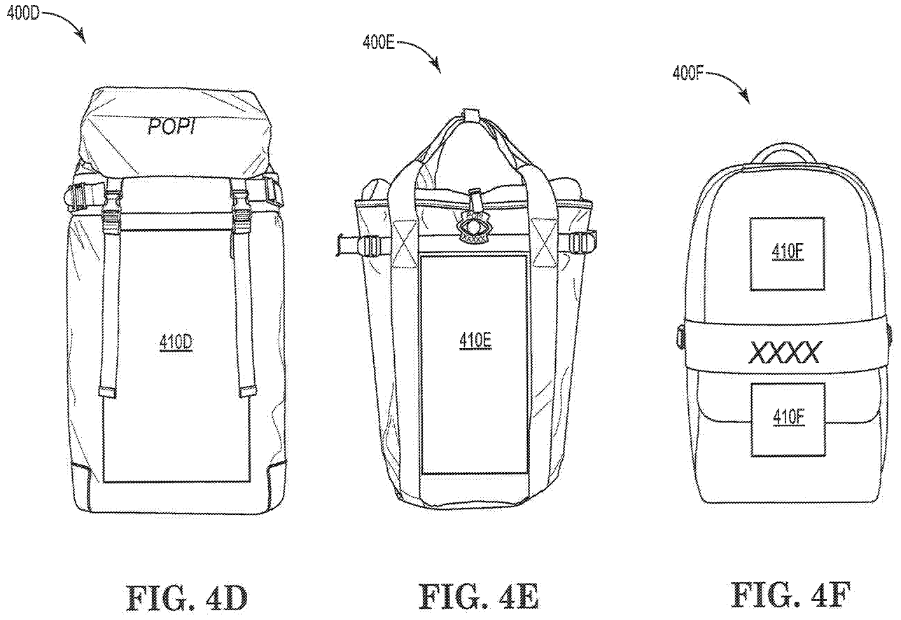

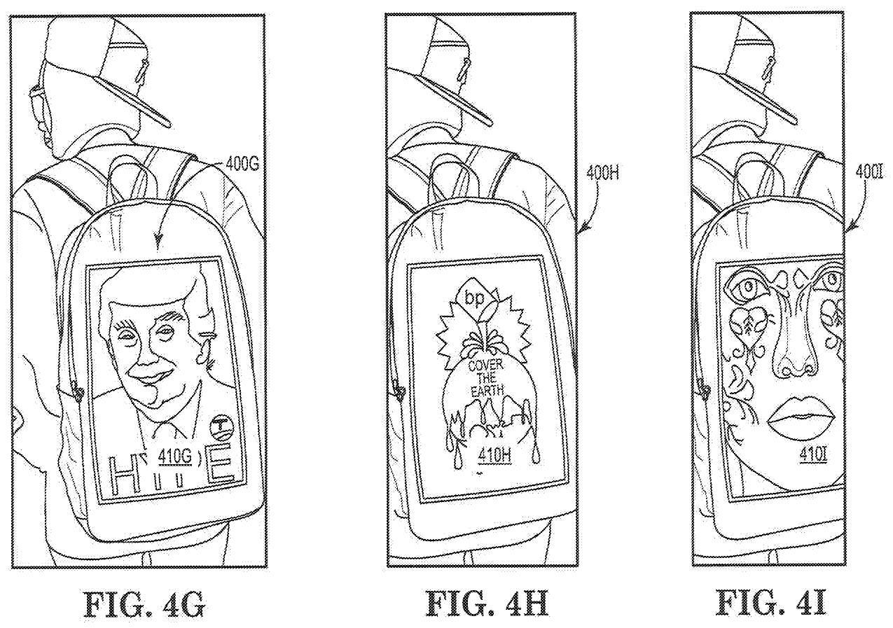

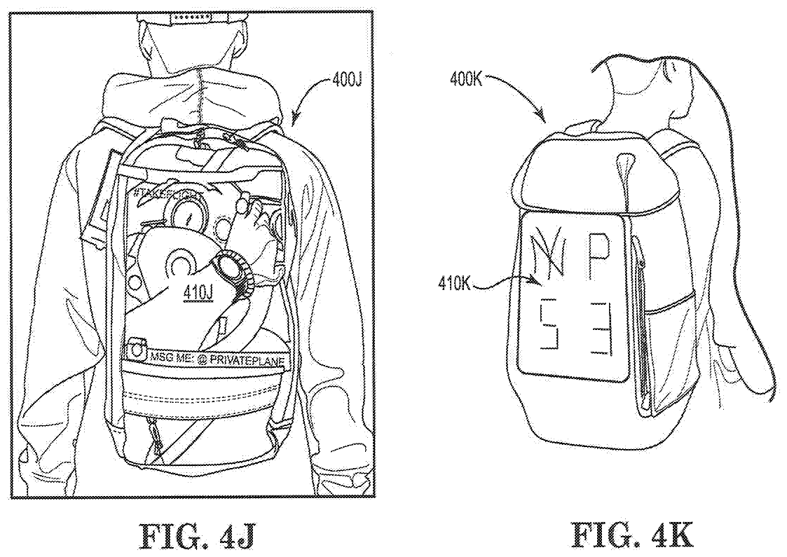

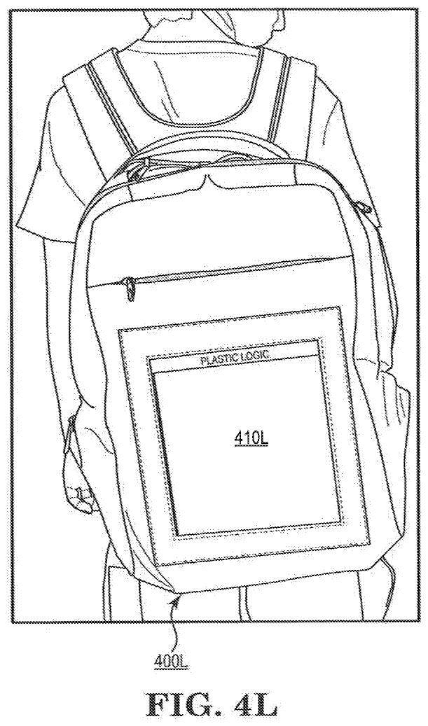

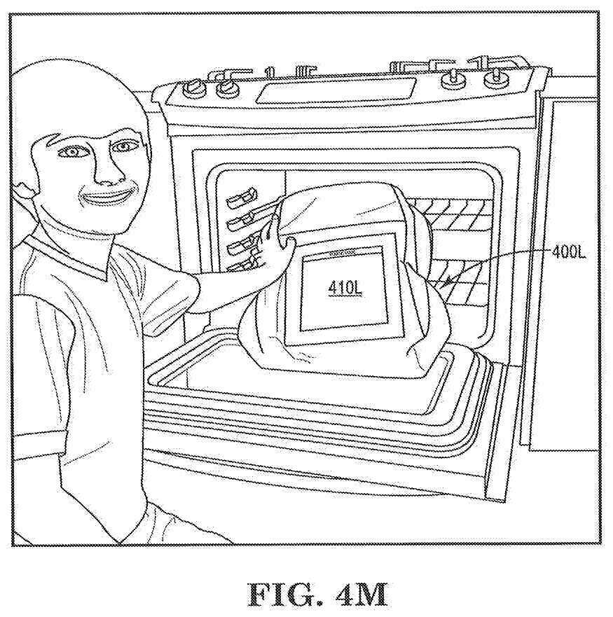

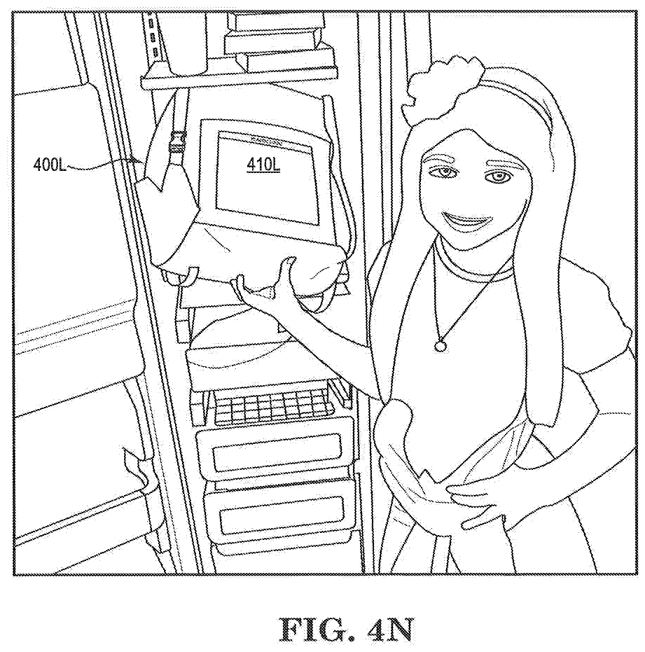

FIGS. 4A-4N show additional examples of backpacks 400 with active elements 410 according to various embodiments of the present disclosure. As may be appreciated, the backpack 400 may have generally any suitable size, shape, and configuration. Moreover, the active element 410 may have any suitable size and shape. The active element 110 may be configured to display various types of images which may be operably selected by a user. For example, the active element may display a color, pattern, photograph, custom image, or other image or series of images, or a video. The active element 110 may display dynamic images in some embodiments. For example, as shown in FIG. 4K, the active element may display the score for a sporting event, and may update during the event as the score changes. In this way, the active element 110 may be configured to update or modify the image automatically based on timing or on an event, for example. Other images, dynamic images, or series of images are contemplated as well. Moreover, a backpack of the present disclosure, including an active element and circuit, may be operable in various environments. For example, a backpack of the present disclosure may be capable of operating while and/or after being subject to various temperatures. As shown in FIGS. 4M-4N for example, a backpack 400 of the present disclosure may be operable at temperatures at or below freezing and/or high temperatures as well.

### Handbag

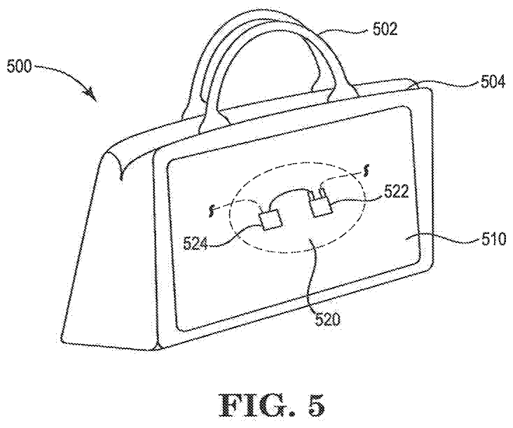

Turning now to FIG. 5, another article of the present disclosure may be a handbag 500 having an active element. The handbag 500 may generally be constructed of canvas, leather, nylon, neoprene, or other materials. The handbag 500 may have one or more carrying straps 502 and one or more storage pockets 504. In some embodiments, the handbag 500 may have a spine portion configured to provide structure to at least a portion of the handbag. Like the backpack 100, the handbag 500 may have an active element 510 positioned on or integrated with the handbag, and a circuit 520 configured to power the active element.

The active element 510 may be similar to the active elements discussed above with respect to the backpacks 100, 400. The active element 510 may be or include one or more displays such as an LED, LCD, OLED, AM-OLED, EPD, or other modifiable display. In some embodiments, the active element 510 may be a color changing conductor configured to change colors depending on the voltage applied to its surface. The active element 510 may be a flexible display in some embodiments. The active element 510 may be configured to display one or more colors, designs, images, series of images, videos, and/or other elements operatively chosen by a user. The active element 510 may be configured to display a dynamic display in some embodiments. The active element 510 may be positioned on or incorporated in a portion or the handbag 500 or the entire outer surface of the handbag, for example. For example, as shown in FIG. 5, the active element 510 may be positioned over an outer face of the handbag 500 such that it may be visible to observers while the handbag is carried by a user. The active element 510 may generally have any suitable size and shape. In some embodiments, a coating, film, or other flexible, transparent material may be positioned over the active element 510 so as to protect the active element from scratches, water damage or other damage. Such material may additionally or alternatively provide for an anti-reflective surface.

The circuit 520 may be similar to the circuits 120, 200 discussed above. The circuit 520 may be generally configured to power the active element 510. The circuit 520 may be positioned on, coupled to, or otherwise integrated with the handbag 500 in various ways, such as positioned in a pocket of the handbag or sewn into a seam, for example. In some embodiments, the circuit 520 or a portion or element(s) thereof may be removable and/or replaceable. The circuit 520 may be rigid or flexible, and each element of the circuit may include a wide range of sophistication depending on the desired ability of adjustment. Similar to the circuits discussed above, the circuit 520 may have a power supply 522 configured to power the circuit and/or active element 510 and a controller 524 configured to send and/or receive instructions to operate the active element 510.

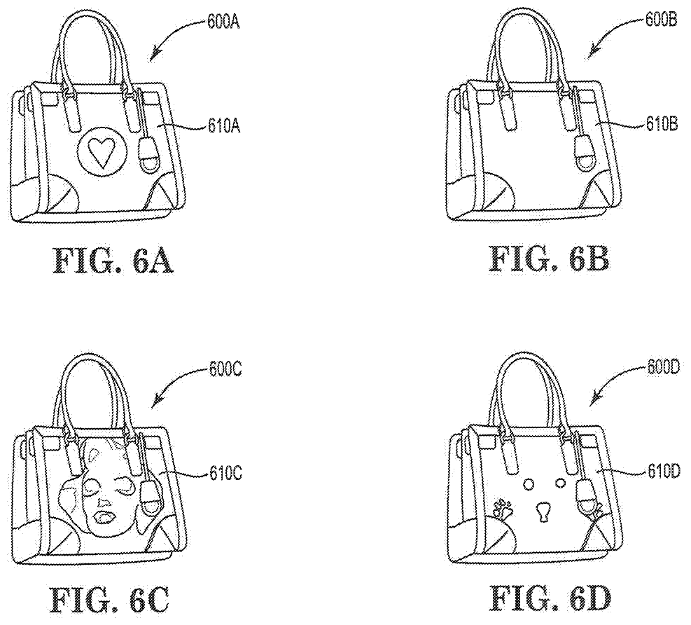

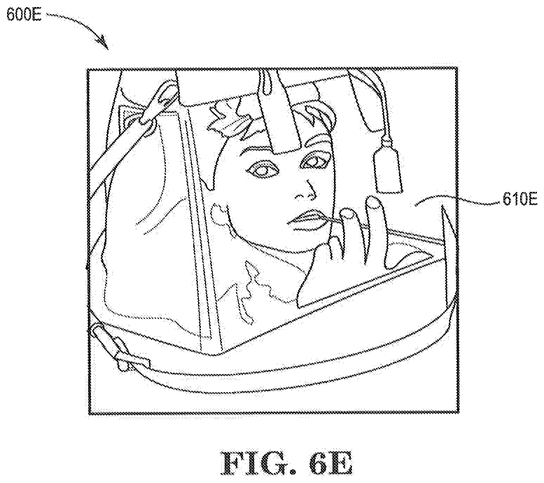

FIGS. 6A-6E show additional examples of handbags 600 with active elements 610 according to various embodiments of the present disclosure. As may be appreciated, the handbag 600 may have generally any suitable size, shape, and configuration. Moreover, the active element 610 may have any suitable size and shape. The active element 610 may be configured to display various types of images which may be operably selected by a user. For example, the active element 610 may display a color, pattern, photograph, custom image, or other image or series of images, or a video. The active element 610 may display dynamic images in some embodiments.

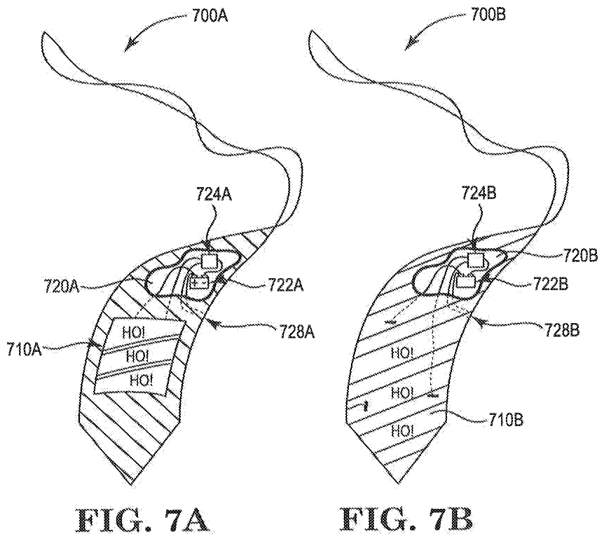

In addition to backpacks, satchels, handbags, purses, totes, and similar items, other articles having active elements are contemplated as well. FIGS. 7-17 illustrate additional articles of the present disclosure and are discussed below.

### Tie

Some articles of the present disclosure may be wearable articles. Turning to FIGS. 7A and 7B, wearable articles are shown in the form of neckties 700, according to some embodiments. Ties have been worn by individuals for generations. Ties may be worn in professional settings and may often be worn with suits. Many ties are made out of silk or other textile materials. Ties may be manufactured in a variety of ways, with the most expensive ties commonly being made by hand. Ties may differ in their specific shapes, sizes, and designs. Indeed, there are hundreds of designer tie labels. In some embodiments, the tie may be a bowtie or the tie may be more elongated hanging necktie. Still other types of ties may include scarves and other textile elements worn around the neck. Individuals that wear ties on a regular basis often prefer to own multiple ties so that they can wear different ties with different shirts. This is because known ties have a static design and the same tie does not commonly properly coordinate with different outfits or settings. Additionally, while it is possible for individuals to create their own tie designs, it is expensive and complicated.

As shown in FIGS. 7A and 7B, a tie 700A/B of the present disclosure may include an active element 710A/B configured to display a color, image, series of images, or other display, and a circuit 720A/B configured to control the active element.

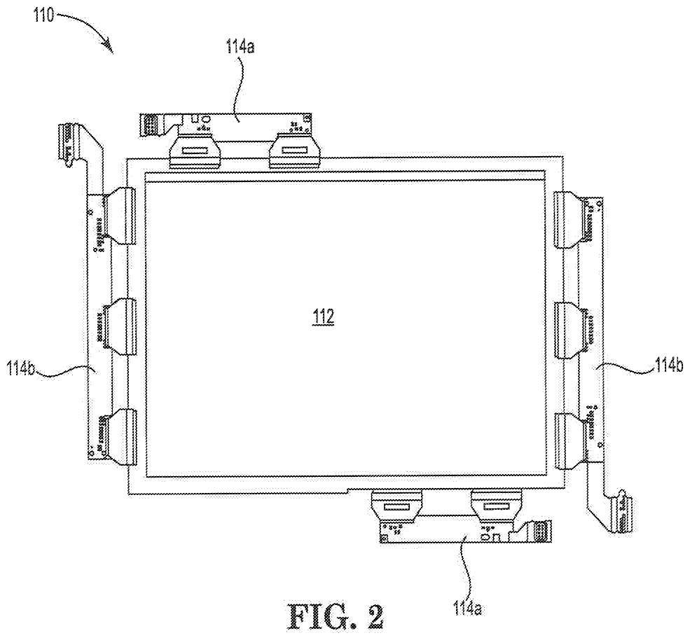

The active element 710A/B may be similar to any of the above described active elements. The active element 710A/B may be or include one or more displays such as an LED, LCD, OLED, AM-OLED, EPD, or other modifiable display. In some embodiments, the active element 710 may be a color changing conductor configured to change colors depending on the voltage applied to its surface. The active element 710 may be a flexible display in some embodiments. The active element 710 may be configured to display one or more colors, designs, images, series of images, videos, and/or other elements operatively chosen by a user. The active element 710 may be configured to display a dynamic display in some embodiments. In some embodiments, as shown in FIG. 2A, the active element 710A may extend over a portion of the tie 700A and in other embodiments as shown in FIG. 2B, the active element 710B may extend over a larger portion or the entire area of the tie 700B including all or a portion of the backside of the tie 100B. In some embodiments, multiple active elements may be provided on the surface of the tie. In some embodiments, a coating, film, or other flexible, transparent material may be positioned over the active element 710 so as to protect the active element from scratches, water damage or other damage. Such material may additionally or alternatively provide for an anti-reflective surface

The circuit 720A/B may be similar to circuits 120, 200, or any of the above described circuits. The circuit 720A/B may be generally configured to power the active element 710A/B. The circuit 720A/B may be positioned on, coupled to, or otherwise integrated with the tie 700 in various ways. In some embodiments, the circuit 720A/B or a portion or element(s) thereof may be removable and/or replaceable. The circuit 720A/B may be rigid or flexible, and each element of the circuit may include a wide range of sophistication depending on the desired ability of adjustment. Similar to the circuits discussed above, the circuit 720A/B may have a power supply 722A/B configured to power the circuit and/or active element 710A/B and a controller 724A/B configured to send and/or receive instructions to operate the active element 710A/B. As described above with respect to circuits 120 and 200, the power supply 722A/B may be rechargeable in some embodiments. In some embodiments, the circuit 720 may include a recharging port 726A/B, as shown in FIGS. 7A and 7B, such as a micro USB or other charging connection. The recharging port 726A/B may be provided on the back or near the edge of the tie 700A/B with circuitry leading to the power supply 722A/B to allow the power supply to be plugged in and recharged. In other embodiments, the power supply 722 may be recharged by other means, such as magnetic or other wireless charging systems.

### Sweatshirt

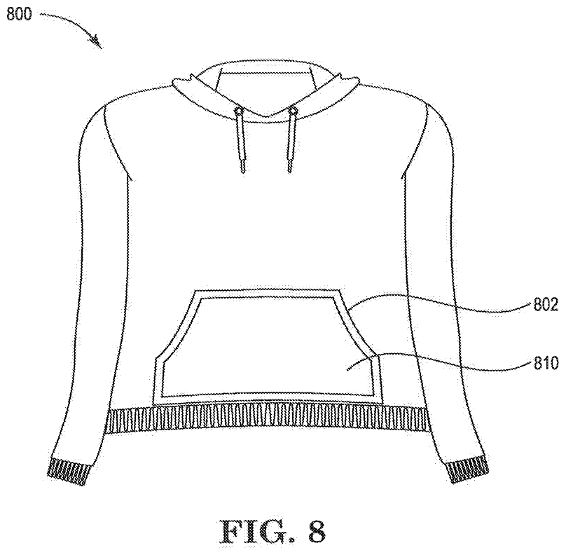

Turning now to FIG. 8, another article of the present disclosure may be an article of clothing such as a shirt, sweatshirt, sweater, jacket, or other article. As illustrated in FIG. 8 for example, one example of an article may be a hooded sweatshirt 800 having an active element 810. The sweatshirt 800 may generally be constructed of cotton, fleece, or other fabrics or materials. The sweatshirt 800 may have one or more pockets 802. In some embodiments, for example, the sweatshirt 800 may have a front pocket 810, such as a kangaroo pocket. The sweatshirt 800 may have an active element 810 positioned on or integrated with the sweatshirt.

The active element 810 may be similar to any of the above described active elements. The active element 810 may be or include one or more displays such as an LED, LCD, OLED, AM-OLED, EPD, or other modifiable display In some embodiments, the active element 810 may be a color changing conductor configured to change colors depending on the voltage applied to its surface. The active element 810 may be a flexible display in some embodiments. The active element 810 may be configured to display one or more colors, designs, images, series of images, videos, and/or other elements operatively chosen by a user. The active element 810 may be configured to display a dynamic display in some embodiments. The active element 810 may be positioned on or incorporated in a portion of the sweatshirt 800. For example, the active element 810 may be positioned over all or a portion of the front pocket 802. In other embodiments, the active element 810 may be positioned on a different location of the sweatshirt 800 or over the entire front or outer surface of the sweatshirt, for example. The active element 810 may generally have any suitable size and shape. In some embodiments, a coating, film, or other flexible, transparent material may be positioned over the active element 810 so as to protect the active element from scratches, water damage or other damage. Such material may additionally or alternatively provide for an anti-reflective surface. The active element 810 may be configured to be relatively durable, such that the sweatshirt 800 may be washed and dried, for example. In other embodiments, the active element 810 may be removable in order to allow washing and drying of the sweatshirt 800.

Additionally, the sweatshirt 800 may have a circuit configured to power the active element 810. The circuit may be similar to circuits 120, 200, or any of the above described circuits. The circuit may be positioned on, coupled to, or otherwise integrated with the sweatshirt 800 in various ways, such as positioned in the pocket 802 of the sweatshirt or sewn into a seam, for example. In some embodiments, the circuit may be removably attached to the sweatshirt 800 such that it may be removed for washing and drying of the sweatshirt, for example. For example, in addition to being electrically coupled to the active element 810, the circuit may be removably attached to the sweatshirt 800, such as inside the pocket 802, via Velcro, snaps, clasps, or other removable attachment means. The circuit may be rigid or flexible, and each element of the circuit may include a wide range of sophistication depending on the desired ability of adjustment. Similar to the circuits discussed above, the circuit may have a power supply configured to power the circuit and/or active element 810 and a controller configured to send and/or receive instructions to operate the active element.

### Hat/Cap

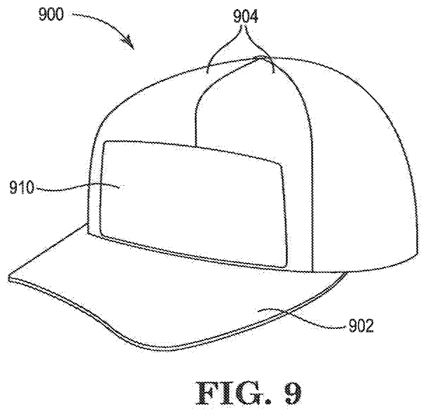

Turning now to FIG. 9, another embodiment of the present disclosure may be a hat, cap, or other head covering. Existing caps, such as baseball caps for example, typically comprise several sections of materials sewn together and a visor. In some cases, the caps are a fixed size; in other cases, a plastic extender is placed on the back of the cap to adjust the size of the cap. Typically, a button sits of the top of the crown where all of the fabric sections converge. Caps are often made of solid-color wool. In some cases, caps are made with plastic mesh and foam. In many cases, stiffening materials are used to bolster the front panels. Examples of stiffening materials include buckram and a plastic insert. Logos or messages can be attached to the front of the cap. As with the ties and sweatshirts discussed above, a fundamental limitation of conventional caps is that the logos or messages displayed on the front of the caps are static. They cannot be easily and immediately changed.

A cap 900 having a modifiable display is shown in FIG. 9. The cap 900 may generally be constructed of plastic, nylon, canvas, or other fabrics or materials. The cap 900 may have a bill or visor 902 extending from a front portion 904 in some embodiments. The cap 900 may have an active element 910 positioned on or integrated with the cap.

The active element 910 may be similar to any of the above described active elements. The active element 910 may be or include one or more displays such as an LED, LCD, OLED, AM-OLED, EPD, or other modifiable display. In some embodiments, the active element 910 may be a color changing conductor configured to change colors depending on the voltage applied to its surface. The active element 910 may be a flexible display in some embodiments. The active element 910 may be configured to display one or more colors, designs, images, series of images, videos, and/or other elements operatively chosen by a user. The active element 910 may be configured to display a dynamic display in some embodiments. The active element 910 may be positioned on or incorporated in a portion of the cap 900. For example, the active element 910 may be positioned on the front portion 904 of the cap 900, above the visor 902, such that the active element may be viewed by observers facing a user while the user wears the cap. In other embodiments, the active element 910 may be positioned on a different location of the cap 900 or over the entire front or outer surface of the cap, for example. The active element 910 may generally have any suitable size and shape. In some embodiments, a coating, film, or other flexible, transparent material may be positioned over the active element 910 so as to protect the active element from scratches, water damage or other damage. Such material may additionally or alternatively provide for an anti-reflective surface.

In some embodiments, the material of the cap 900 may be similar to a back substrate of the active element 910. For example, both the back substrate of the active element 910 and the cap itself 900 may be comprised of PET. The active element 910 may be attached to the cap 900 through several techniques, such as sewing, adhesive, heat treatment, or other means.

The cap 900 may additionally have a circuit configured to power the active element 910. The circuit may be similar to circuits 120, 200, or any of the above described circuits. In some embodiments, the circuit or a portion or element(s) thereof may be removable and/or replaceable. The circuit may be rigid or flexible, and each element of the circuit may include a wide range of sophistication depending on the desired ability of adjustment. Similar to the circuits discussed above, the circuit may have a power supply configured to power the circuit and/or active element 910 and a controller configured to send and/or receive instructions to operate the active element.

The circuit may be positioned on, coupled to, or otherwise integrated with the cap 900 in various ways. Generally, the circuit, along with drivers, cables, or other connection components between the circuit and active element 910 may be hidden from view while a user wears the cap 900. For example, in some embodiments, the circuit may be positioned on an inner surface of the cap 900. The cap 900 may have an enclosed lining, which may serve as a protective layer from the circuit and/or cables, drivers, or other components. Such lining may be composed of plastic in some embodiments. In other embodiments, the cap 900 may have one or more openings or pockets that allow for the circuit and any cables, drivers, or components to be positioned within the cap 900. For example, the opening may be positioned on a bottom of one of the sides of the front portion 904 of the cap 900 such that a cable, driver, and/or component attached to the active element 910 may be positioned in the interior of the cap. In some embodiments, a cable or other connector electrically coupling the active element 910 to the circuit, for example, may be positioned inside the cap 900 on an inner top portion or inner side portion of the cap, for example. In a specific embodiment, the display drivers for the active element 910 may be positioned on a bottom corner (either side) of the display screen, and the display drivers may be attached to the side of the inside portion of the hat. In some embodiments, the circuit may be movable to different locations of the cap 900. The size of the cable or other connector coupling the active element 910 to the circuit may be adjusted appropriately such that the cable can connect to the circuit at a different location on the cap. In another embodiment, the circuit may be positioned on or integrated with a plastic sizing extender on the back of the cap 900.

### Shoe

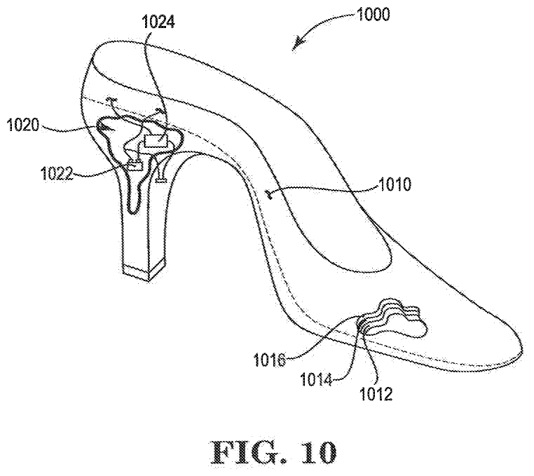

Referring now to FIG. 10, another embodiment of an article 1000 is shown. In this embodiment, an article of footwear 1000, such as a woman's high-heel shoe, having a modifiable display is shown. The shoe 1000 may generally be constructed of plastic, leather, canvas, or other materials. The shoe 1000 may have an active element 1010 positioned on or integrated with the shoe and a circuit 1020 configured to power the active element

The active element 1010 may be similar to any of the above described active elements. The active element 1010 may be or include one or more displays such as an LED, LCD, OLED, AM-OLED, EPD, or other modifiable display. The active element 1010 may be configured to display one or more colors, designs, images, series of images, videos, and/or other elements operatively chosen by a user. The active element 1010 may be configured to display a dynamic display in some embodiments. In some embodiment, as shown in FIG. 10 for example, the shoe 1000 may include an active element 1010 in the form of a multi-layered coating on the surface of the shoe that can be electronically programmed to change colors. The multi-layered coating may include a layer of plastic 1012, an active color changing layer 1014, and a conductor 1016 in some embodiments. The plastic layer 1012 may be PET, polyethylene napthatlate (“PEN”), or any other suitable material. The color changing layer 1014 may include an organic material that changes different colors in response to different electrical charges. In some embodiments, the color changing layer 1014 may include an electrochromic polymer for example. The conductor 1016 may be made of a variety of different materials. In some embodiments, for example, the conductor 1016 may be comprised of a flexible film of carbon nanotubes. The current flowing through the conducting film may activate the color changing layer 1014. Each layer of the multi-layered coating may be rigid or flexible. In other embodiments, the multi-layered coating may have other layers. The multi-layered coating may be fabricated using high speed printing processes in some embodiments.

The active element 1010 may be positioned on or incorporated in a portion of the shoe 1000. For example, the active element 1010 may cover an entire outer surface of the shoe 1000. The active element 1010 may generally have any suitable size and shape. In some embodiments, a coating, film, or other flexible, transparent material may be positioned over the active element 1010 so as to protect the active element from scratches, water damage or other damage. Such material may additionally or alternatively provide for an anti-reflective surface.

The circuit 1020 may be similar to circuits 120, 200, or any of the above described circuits. The circuit 1020 may be generally configured to power the active element 1010. The circuit 1020 may be positioned on, coupled to, or otherwise integrated with the shoe 1000 in various ways, such as positioned within a heel portion of the shoe, for example. In some embodiments, the circuit 1020 may be removable and/or replaceable. The circuit 1020 may be rigid or flexible, and each element of the circuit may include a wide range of sophistication depending on the desired ability of adjustment. Similar to the circuits discussed above, the circuit 1020 may have a power supply 1022 configured to power the circuit and/or active element 1010 and a controller 1024 configured to send and/or receive instructions to operate the active element. In some embodiments, the controller 1024 may be a relatively simple resistive element or adjustable resistive element such as a concealed dial or slide mechanism for adjusting the voltage seen by the conductor 1016 of the active element 1010, thus, affecting the color of the shoe 1000. However, in other embodiments, the controller 1024 may be a more sophisticated circuit, chip, and/or processor configured for communications with one or more other devices via a wired or wireless connection, as described above.

### Sandal

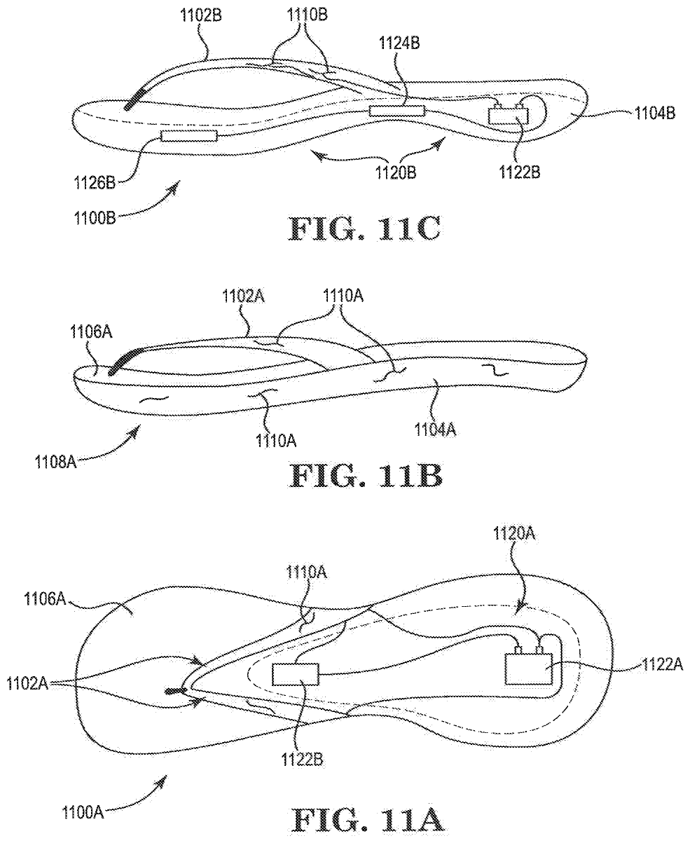

Referring now to FIGS. 11A-11C, another embodiment of an article 1100A/B is shown. In this embodiment, a sandal 1100A/B having a modifiable display is shown. The sandal 1100A/B may generally be constructed of plastic, leather, foam, canvas, or other materials. The sandal 1100A/B may have one or more straps 1102A/B configured for positioning over or around a user's foot, and a base 1104A/B having a top portion 1106 and a bottom portion 1108A/B. The sandal 1100A/B may additionally have an active element 1110A/B positioned on or integrated with the sandal and a circuit 1120A/B configured to power the active element.

The active element 1010A/B may be similar to any of the above described active elements. The active element 1110A/B may be or include one or more displays such as an LED, LCD, OLED, AM-OLED, EPD, or other modifiable display. In some embodiments, the active element 1110A/B may be a color changing conductor configured to change colors depending on the voltage applied to its surface. The active element 1110A/B may be a flexible display in some embodiments. The active element 1110A/B may be configured to display one or more colors, designs, images, series of images, videos, and/or other elements operatively chosen by a user. The active element 1110A/B may be configured to display a dynamic display in some embodiments. The active element 1110A/B may be positioned on or incorporated in a portion of the sandal 1100A/B. For example, the active element 1110A/B may be positioned on or incorporated in one or more straps 1102A/B. Additionally, or alternatively, the active element 1110A/B may be positioned on or incorporated in the base 1104A/B, such as on the top 1106A/B and/or bottom 1108A/B portion. In other embodiments, the active element 1110A/B may be positioned on a different location of the sandal 1100A/B. The active element 1110A/B may generally have any suitable size and shape. In some embodiments, a coating, film, or other flexible, transparent material may be positioned over the active element 1110A/B so as to protect the active element from scratches, water damage or other damage. Such material may additionally or alternatively provide for an anti-reflective surface.

The circuit 1120A/B may be similar to circuits 120, 200, or any of the above described circuits. The circuit 1120A/B may be generally configured to power the active element 1110A/B. Similar to the circuits discussed above, the circuit 1120A/B may have a power supply 1122A/B configured to power the circuit and/or active element 1110A/B and a controller 1124A/B configured to send and/or receive instructions to operate the active element. The circuit 1120A/B may be positioned on, coupled to, or otherwise integrated with the sandal 1100A/B in various ways, such as positioned within the base 1104A/B of the sandal, for example Where the active element 1100A/B is positioned on or incorporated in one or more straps 1102A/B, the circuitry may connect from the power source 1122A/B stored in the base 1104A/B, to the strap through posterior and/or anterior sandal strap connection points. In other embodiments, any suitable configuration to connect the active element 1110A/B to the circuit 1120A/B may be used. In some embodiments, the circuit 1120A/B may be removable and/or replaceable. The circuit 1120A/B may be rigid or flexible, and each element of the circuit may include a wide range of sophistication depending on the desired ability of adjustment.

In some embodiments, as demonstrated in FIG. 11C, the circuit 1120 may include one or more sensors 1126B. The sensor 1126B may detect when a user is using the sandal 1100B, for example, thereby activating the active element 1110B via the controller 1124B. The sensor 1126B may be a weight or pressure sensor in some embodiments. In other embodiments, the sensor 1126B may be an accelerometer. Any suitable method to determine when the active elements should be activated may be used. The use of the sensor 1126B to monitor use may keep the power turned off when the article is not in use, thereby saving the power supply.

### Boot

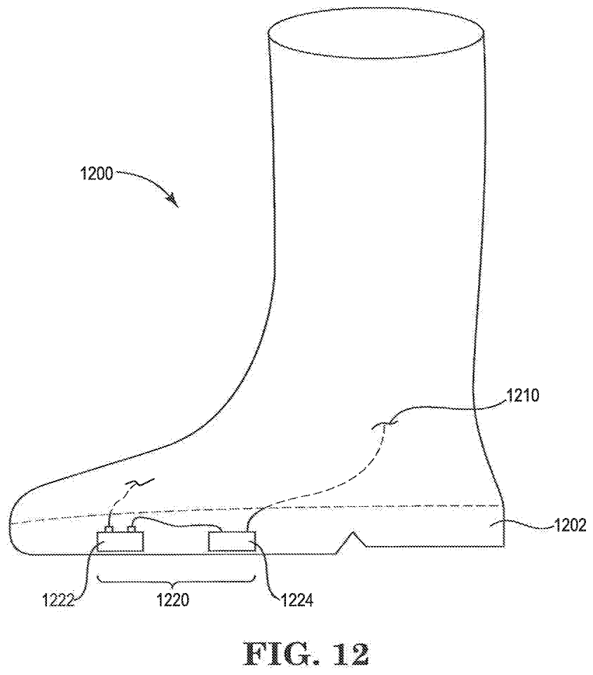

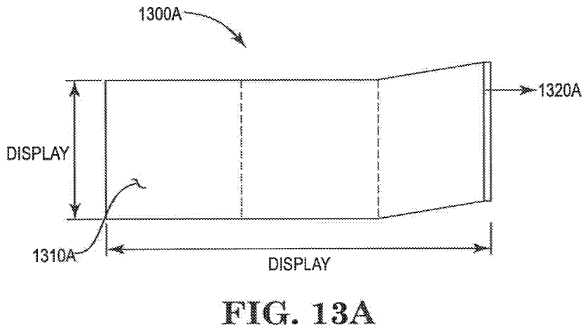

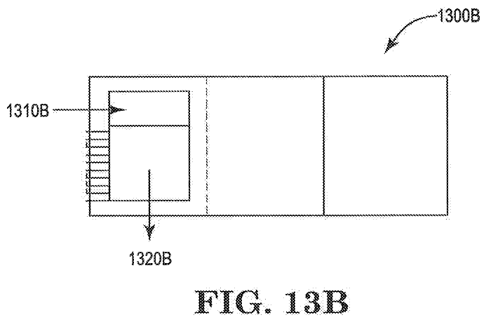

Referring now to FIG. 12, another embodiment of an article 1200 is shown in the form of a boot, such as a rain boot, having a modifiable display. The boot 1200 may generally be constructed of vinyl, polyvinyl chloride (PVC), other plastics, or other materials. The boot 1200 may have a sole 1202 which may be a base portion of the boot. The boot 1200 may have an active element 1210 positioned on or integrated with the boot, and a circuit 1220 configured to power the active element.

The active element 1210 may be similar to any of the above described active elements. The active element 1210 may be or include one or more displays such as an LED, LCD, OLED, AM-OLED, EPD, or other modifiable display. In some embodiments, the active element 1210 may be a color changing conductor configured to change colors depending on the voltage applied to its surface. The active element 1210 may be a flexible display in some embodiments. The active element 1210 may be configured to display one or more colors, designs, images, series of images, videos, and/or other elements operatively chosen by a user. The active element 1210 may be configured to display a dynamic display in some embodiments. The active element 1210 may be positioned on or incorporated in a portion of the boot 1200. For example, the active element 1210 may be positioned over all or a portion of an outer surface of the boot, such that the active element may be visible to observers while a user wears the boot. In other embodiments, the active element 1210 may be positioned on a different location of boot 1200. The active element 1210 may generally have any suitable size and shape. In some embodiments, a coating, film, or other flexible, transparent material may be positioned over the active element 1210 so as to protect the active element from scratches, water damage or other damage. Such material may additionally or alternatively provide for an anti-reflective surface.

The circuit 1220 may be similar to circuits 120, 200, or any of the above described circuits. The circuit 1220 may be generally configured to power the active element 1210. The circuit 1220 may be positioned on, coupled to, or otherwise integrated with the boot 1200 in various ways, such as positioned within the sole 1202 of the boot, for example. In some embodiments, the circuit 1220 may be removable and/or replaceable. The circuit 1220 may be rigid or flexible, and each element of the circuit may include a wide range of sophistication depending on the desired ability of adjustment. Similar to the circuits discussed above, the circuit 1220 may have a power supply 1222 configured to power the circuit and/or active element 1210 and a controller 1224 configured to send and/or receive instructions to operate the active element. In some embodiments, the circuit 1220 may have a sensor, similar to that described above with respect to the sandal 1100.

### Wallet

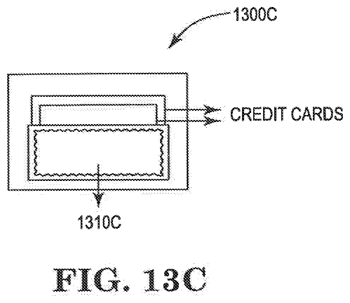

Referring now to FIGS. 13A-13C, yet another embodiment of an article 1300 is shown in the form of a wallet. A wallet is a small holding case used for carrying money, documents or other items. Wallets may come in various sizes, shapes, and colors. Many wallets are made of leather while others are made of plastic or rubber. The materials used to fabricate wallets is often highly durable. Wallets are generally subject to stretching, bending, elongation, and other mechanical shocks. Flexible displays have been demonstrated that can bend or fold. However, while these displays can survive some bending, they might not sustain elongation. Accordingly, flexible displays may not be thought of as being capable of integration into wallets.

Flexible, plastic displays such as flexible electrophoretic displays (“EPD”) and flexible OLED displays have been demonstrated. However, due to the fragility of some of the electronic materials used to make these displays, they may be sensitive to and may not sustain elongation. However, new materials such as transparent conductive films made of carbon nanotubes may be used to make passive matrix EPD displays that can sustain elongation.

Accordingly, another embodiment may include a wallet 1300A comprising an active element 1310A and a circuit 1320A.

The active element 1310A may be similar to any of the above described active elements. The active element 1310A may be or include one or more displays such as an LED, LCD, OLED, AM-OLED, EPD, or other modifiable display. In some embodiments, the active element 1310A may be a color changing conductor configured to change colors depending on the voltage applied to its surface. The active element 1310A may be a flexible display in some embodiments. The active element 1310A may be configured to display one or more colors, designs, images, series of images, videos, and/or other elements operatively chosen by a user. The active element 1310A may be configured to display a dynamic display in some embodiments. The active element 1310A may be positioned on or incorporated in a portion of the wallet 1300A. For example, the active element 1310A may be positioned over all or a portion of an outer surface of the wallet, as shown in FIG. 13A. The active element 1310A may serve as the outside layer of the wallet 1300A, or it may be attached to (either sewn into or glued to) the outer surface of the wallet. In other embodiments, the active element 1310A may be positioned on a different location of the wallet 1300A. The active element 1310A may generally have any suitable size and shape. In some embodiments, a coating, film, or other flexible, transparent material may be positioned over the active element 1310A so as to protect the active element from scratches, water damage or other damage. Such material may additionally or alternatively provide for an anti-reflective surface.

The circuit 1320A may be similar to the circuits 120, 200, or any of the above described circuits. The circuit 1320A may be generally configured to power the active element 1310A. The circuit 1320A may be positioned on, coupled to, or otherwise integrated with the wallet 1300A in various ways, such as positioned at or near one edge of the wallet, such as a right edge as shown in FIG. 13A. In some embodiments, the circuit 1320A may be removable and/or replaceable. The circuit 1320A may be rigid or flexible, and each element of the circuit may include a wide range of sophistication depending on the desired ability of adjustment. Similar to the circuits discussed above, the circuit 1320A may have a power supply 1322A configured to power the circuit and/or active element 1310A and a controller 1324A configured to send and/or receive instructions to operate the active element.

In FIG. 13B, an example of how the circuit board and energy system might be embedded in the front side of the wallet 1300B is shown.

Referring to FIG. 13C, another embodiment may include a wallet 1300C comprising an active element 1310C capable of elongation that is located on a particular part of the wallet. The active element 1310C may be integrated into the leather cover that holds cards on the inside of the wallet 1300C. The circuit might be embedded in the wallet 1300C behind the display, for example.

### Belt

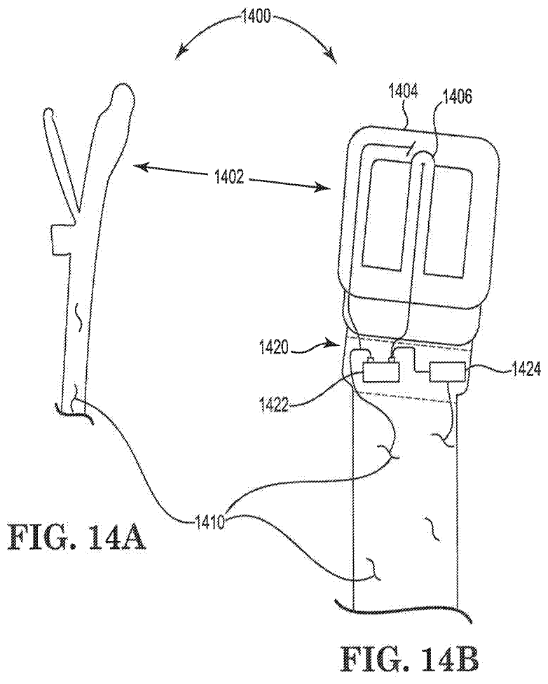

Referring now to FIGS. 14A-14B, yet another embodiment of an article 1400 is shown in the form of a belt. A belt is a strap used for holding clothes in place or for other decorative purposes. Belts may come in various sizes, shapes, and colors. Conventionally, some belts may be reversible, giving a user two color or design options in one belt. Many belts are made of leather while others are made of plastic or rubber. The materials used to fabricate belts are often highly durable. Belts are generally subject to stretching, strain, elongation, and other mechanical shocks. Similar to the wallets discussed above, the display may serve as the outside layer of the belt, or it may be attached to (either sewn into or glued to) the outer surface of the belt. The display can be (but is not limited to) an EPD display or an OLED display.

The belt 1400 may have a buckle portion 1402 having a loop 1404 and a needle 1406, together configured to position the belt around a user's waist. The belt may further have an active element 1410, which may be similar to any of the active elements described above. The belt 1400 may have a circuit 1420, which may be similar to any of the circuits described above. The circuit 1420 may have a power supply 1422 and a controller 1424.

The active element 1410 may be similar to any of the above described active elements. The active element 1410 may be or include one or more displays such as an LED, LCD, OLED, AM-OLED, EPD, or other modifiable display. In some embodiments, the active element 1410 may be a color changing conductor configured to change colors depending on the voltage applied to its surface. The active element 1410 may be a flexible display in some embodiments. The active element 1410 may be configured to display one or more colors, designs, images, series of images, videos, and/or other elements operatively chosen by a user. The active element 1410 may be configured to display a dynamic display in some embodiments. The active element 1410 may be positioned on or incorporated in a portion of the belt 1400. For example, the active element 1410 may be positioned over all or a portion of an outer surface of the belt, such that the active element may be visible to observers while a user wears the belt. In other embodiments, the active element 1410 may be positioned on a different location of belt 1400. The active element 1410 may generally have any suitable size and shape In some embodiments, a coating, film, or other flexible, transparent material may be positioned over the active element 1410 so as to protect the active element from scratches, water damage or other damage. Such material may additionally or alternatively provide for an anti-reflective surface.

The circuit 1420 may be similar to the circuits 120, 200, or any of the above described circuits. The circuit 1420 may be generally configured to power the active element 1410. The circuit 1420 may be positioned on, coupled to, or otherwise integrated with the belt 1400 in various ways, such as positioned within the buckle portion 1402, for example. In some embodiments, the circuit 1420 may be removable and/or replaceable. The circuit 1420 may be rigid or flexible, and each element of the circuit may include a wide range of sophistication depending on the desired ability of adjustment. Similar to the circuits discussed above, the circuit 1420 may have a power supply 1422 configured to power the circuit and/or active element 1410 and a controller 1424 configured to send and/or receive instructions to operate the active element.

In some embodiments, the circuit 1420 may be integrated with the buckle portion 1402 such that the buckle portion may be configured to complete the circuit, and thus power the active element 1410. As seen in the embodiment of FIG. 14B, when the buckle portion 1402 is closed, or the belt needle 1406 comes into contact with the belt loop 1404, the active elements 1410 may be activated to display a desired color, pattern, or other display. When the belt needle 1406 is no longer in contact with the belt loop 1404 as seen in FIG. 14A, the active element 1410 may be deactivated, thereby saving the power supply of the belt when it is not in use. A belt hung-up in a closet for example may greatly conserve power using this technique.

In other embodiments, the belt 1400 may also be incorporated with a sensor to activate or deactivate the active elements. For example, a belt used on luggage to help the user identify their bag at baggage claim may incorporate a sensor to sense when the plane is landing, such as an altimeter or other device measuring pressure changes. The sensor may activate the active element in the belt upon landing making the belt easily visible and distinguishable from other luggage. In some embodiments, the belt may turn off automatically after a predetermined amount of time. In still other embodiments, the belt may be turned off manually by the user.

### Notebook/Journal

In addition to wearable articles and accessories, modifiable displays may be incorporated on various other items, such as useful items, household items, office supplies, decorations, toys, and other items.

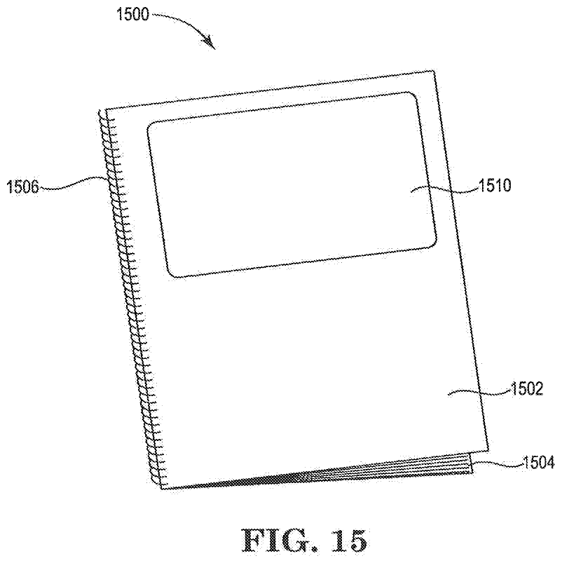

Referring now to FIG. 15, another embodiment of an article 1500 is shown in the form of a notebook or journal having a modifiable display. The notebook 1500 may have a front cover 1502, back cover 1504, and a spine 1506 binding the covers together in some embodiments. The front cover 1502 and back cover 1504 may be composed of paper, plastic, or other suitable materials. Further, the notebook 1500 may have an active element 1510 positioned on or integrated with the boot.

The active element 1510 may be similar to any of the above described active elements. The active element 1510 may be or include one or more displays such as an LED, LCD, OLED, AM-OLED, EPD, or other modifiable display. In some embodiments, the active element 1510 may be a color changing conductor configured to change colors depending on the voltage applied to its surface. The active element 1510 may be a flexible display in some embodiments. The active element 1510 may be configured to display one or more colors, designs, images, series of images, videos, and/or other elements operatively chosen by a user. The active element 1510 may be configured to display a dynamic display in some embodiments. The active element 1510 may be positioned on or incorporated in a portion of the notebook 1500. For example, the active element 1510 may be positioned over all or a portion of the front cover 1502 of the notebook. In other embodiments, the active element 1510 may be positioned on a different location of the notebook 1500. The active element 1510 may generally have any suitable size and shape. In some embodiments, a coating, film, or other flexible, transparent material may be positioned over the active element 1510 so as to protect the active element from scratches, water damage or other damage. Such material may additionally or alternatively provide for an anti-reflective surface.

Additionally, the notebook 1500 may have a circuit configured to power the active element 1510. The circuit may be similar to the circuits 120, 200 or any of the above described circuits. The circuit may be positioned on, coupled to, or otherwise integrated with the notebook 1500 in various ways, such as positioned on or within the spine 1506 of the notebook, for example. In some embodiments, the circuit may be removably attached to the notebook 1500. The circuit may be rigid or flexible, and each element of the circuit may include a wide range of sophistication depending on the desired ability of adjustment. Similar to the circuits discussed above, the circuit may have a power supply configured to power the circuit and/or active element 1510 and a controller configured to send and/or receive instructions to operate the active element.

### Bicycle Decoration

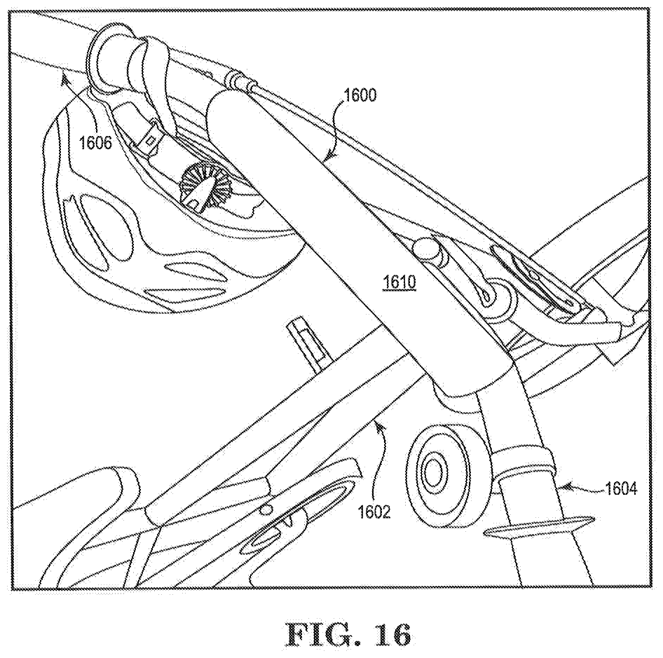

Referring now to FIG. 16, another embodiment of an article 1600 is shown in the form of a bicycle decoration having a modifiable display. The bicycle decoration 1600 may be a wrap, cover, padding, or other element that may be configured to wrap around a portion of a bicycle 1602. For example, as shown in FIG. 16, the decoration 1600 may be a foam or plastic piece, for example, configured to wrap around a middle portion 1604 of the bicycle 1602, which may be positioned between two handlebars 1606. Tin other embodiments, the decoration 1600 may be wrapped or positioned around a different portion of the bicycle 1602, such as around a different bar portion between front and rear wheels, for example. The decoration 1600 may have an active element 1610 positioned on or integrated with the decoration.

The active element 1610 may be similar to any of the above described active elements. The active element 1610 may be or include one or more displays such as an LED, LCD, OLED, AM-OLED, EPD, or other modifiable display. In some embodiments, the active element 1610 may be a color changing conductor configured to change colors depending on the voltage applied to its surface. The active element 1610 may be a flexible display in some embodiments. The active element 1610 may be configured to display one or more colors, designs, images, series of images, videos, and/or other elements operatively chosen by a user. The active element 1610 may be configured to display a dynamic display in some embodiments. The active element 1610 may be positioned on or incorporated in a portion of the bicycle decoration 1600. For example, the active element 1610 may be positioned over all or a portion of an outer surface of the decoration 1600. The active element 1610 may generally have any suitable size and shape. In some embodiments, a coating, film, or other flexible, transparent material may be positioned over the active element 1610 so as to protect the active element from scratches, water damage or other damage. Such material may additionally or alternatively provide for an anti-reflective surface.

Additionally, the decoration 1600 may have a circuit configured to power the active element 1610. The circuit may be similar to the circuits 120, 200 or any of the above described circuits. The circuit may be positioned on, coupled to, or otherwise integrated with the bicycle decoration 1600 in various ways. In some embodiments, the circuit may be removably attached to the decoration 1600. The circuit may be rigid or flexible, and each element of the circuit may include a wide range of sophistication depending on the desired ability of adjustment. Similar to the circuits discussed above, the circuit may have a power supply configured to power the circuit and/or active element 1610 and a controller configured to send and/or receive instructions to operate the active element.

### Other Articles

In addition to the articles described above, other articles having modifiable displays are contemplated in the present application. Generally, any item or product may have a modifiable display, such as those described above, incorporated onto a surface of the item, thus allowing for a level of personalization or customization of the item or product.

An additional example of an article of the present disclosure may be a pillow, such as a throw pillow, having a modifiable display. The display may be or include an active element, which may be similar to any of the active elements discussed above. The active element may be positioned over a portion of the pillow surface, such as on a front and/or back side of the pillow. The pillow may be modified to display various colors, patterns, or other images chosen by the user. For example, the pillow may be configured to display a message or saying, selected by the user. A connected circuit may be positioned within the pillow, such as within the cushioning of the pillow or within a seam. The circuit may be similar to circuits 120, 200, or any of the above described circuits. In some embodiments, the pillow may be chargeable via a charging port or other charging means. In some embodiments, the pillow, including the active element, may be constructed using generally comfortable materials. For example, the active element and/or an outer substrate of the active element may be constructed with a comfortable plastic material, such as PVC or other materials.

An additional example of an article of the present disclosure may be a pouch or carrying case, such as a coin purse or pencil pouch, having a modifiable display. The pencil pouch may be closeable using a zipper, flap, latch, snap, or other element. The pencil pouch may be constructed of plastic, vinyl, or other suitable materials. The modifiable display may be or include an active element, which may be similar to any of the above described active elements. The active element may be positioned over a portion of an outer surface of the pencil pouch. A connected circuit may be positioned within the pencil pouch, such as within a pocket of the pouch or within a seam. The circuit may be similar to circuits 120, 200, or any of the above described circuits. The pencil pouch may be modifiable to display various colors, patterns, or other images chosen by the user.

Other articles having modifiable displays are contemplated as well. Appendix A of the present disclosure illustrates some examples of additional articles having modifiable displays. As shown in Appendix A, for example, a T-shirt, a jacket, a wallet and phone case, or an article of jewelry may have a modifiable display of the present disclosure.

### Stickers

In keeping with the above embodiments relating to display articles, another embodiment involving paper stickers may be provided. For example, the sticker may include a circuit similar to the circuit 120, 200, or any of the circuits described above. Paper stickers can be placed most anywhere, ranging from car bumpers to the wall of a bedroom. In many cases, large paper stickers are used to express one's likes, thoughts, or feelings. For example, people may place bumper stickers on their car that advance political commentary or support a particular sports team. Similarly, children that like pirates might place stickers of pirates on the walls in their bedroom. Stickers include a static appearance and generally are used to communicate a single message. A bumper sticker placed on the back of a car may not, without more, display a different, customized message from moment to moment.

An electronic sticker may include a relatively thin, flexible display that may be directly attached to a surface by a separable attachment. Examples of separable attachments may include adhesives and magnets. The sticker may, thus, be capable of attaching to a non-flat surface. Like the previous embodiments, the electronic sticker may include a modifiable display, which may be or include an active element, and a circuit.

The active element may be similar to any of the above described active elements. The active element may be flexible. Like the above-described embodiments, the active element may include such flexible display technologies as flexible LED, LCD, OLED, AM-OLED, EPD, or other display technologies.

The circuit may include a controller in the form of a circuit board, and a power supply in the form of an energy storage system, and may be similar to circuits 120, 200, or any of the above described circuits. The circuit board can be thin and rigid or flexible. The battery can be a thin, flexible battery. The battery can be capable of being recharged or replaceable. Plastic films such as PET or PEN are used as the front and back surfaces of the electronic sticker. The display can range in thickness from 0.5 millimeter to 5 millimeters.

The electronic sticker may be relatively thin and can be attached to a surface by a separable attachment. In some embodiments, an electronic sticker may be provided including an adhesive on the back side and attached to a release liner. When the electronic sticker is removed from the release liner, it can be fastened to a surface. The surface of the sticker can be attached to a non-flat surface. For example, it can be wrapped around sharp angles. The adhesive can be adhesives used to attach traditional, paper stickers to surfaces.

Another embodiment of the invention is an electronic sticker comprising a magnet on the back side. The magnet may be sufficiently thin and, thus flexible, such that the electronic sticker can be attached to a non-flat surface.

Another embodiment may include an electronic sticker for use in the outdoors comprising a solar cell for purposes of supplementing and/or replacing the power supply. Examples of solar cell technologies that might be used, but are not limited to, organic, CIGs, and dye sensitized. In another embodiment, the electronic sticker may include a protective casing for the power supply so that the recharging mechanism for the battery is not subject to rust and other weather related damage.

Unlike some of the above described embodiments, such as a belt or shoe, for example, stickers may be more likely to be positioned at a location and left there in the absence of a user. Accordingly, while the sticker may have circuitry for communicating with a user like the other articles described, the sticker may also include an authorization system for enabling third party electronic devices such as smart phones to communicate with an electronic sticker. For example, if a user places an electronic sticker on the refrigerator in the kitchen of a home, he or she may desire multiple parties in the house to be able to use their smart phones to upload content to the electronic sticker. The system may include (1) a mechanism for the owner of the electronic sticker to identify third parties that are authorized to upload content to the electronic sticker; and (2) a mechanism for third parties to submit content to the electronic sticker. Various methods might be used for the owner of the electronic sticker to identify third parties authorized to upload content to the electronic sticker. In one embodiment, the owner of the electronic sticker can go to a web site and provide the identifying information (e.g. a phone number) associated with each mobile device that can upload content to the electronic sticker. The server hosting the web site may communicate directly with the electronic sticker. Several mechanisms might be used for third parties to submit content to the electronic sticker. In one embodiment, each person controlling a mobile device can download an “App” to his or her mobile device. The App may allow the person to submit content such as words, symbols, or pictures to the electronic sticker. The content can be securely transferred from the mobile device to the server and then to the electronic sticker.

Another embodiment may include an electronic patch comprised of an active element, a controller, and a power supply, similar to that of the previous described embodiments. The patch can be completely flexible and bendable or it may have a rigid plastic layer on one end of the patch. The rigid plastic layer can be used to encase the wireless communication system, display drive electronics, energy storage system, and Micro UISB connection. The patch can contain an adhesive layer on the back side, so that the patch can be transferred to and firmly attached to several different materials, such as clothing. An example of the adhesive material may include a hook and loop material such as Velcro®. The back side of the patch may also contain clips to attach the patch to different surfaces. In some embodiments, the electronic patch may be approximately 4 inches in length by 2.5 inches in width. The patch may also be less than 1 millimeter in thickness. Still other lengths, widths, and thicknesses may be provided. The top of the electronic patch may include a rigid plastic encasing for a wireless communication system, display drive electronics, energy storage system, and MICRO-USB connection. The display may include a color E-Paper display or one of the other types of displays may be used. The transistors in the display may be flexible and comprised of polymers. The conductors may be flexible and may be carbon nanotube films. The electronic patch may communicate with a mobile device. The mobile device may transmit signals to the electronic patch to display words, pictures, and designs. For example, an individual can transmit his or her Instagram feed to the electronic patch worn on his or her clothes.

### Moldable Products

In addition to the wearable articles, accessories, stickers, and other articles discussed above, some articles of the present disclosure may be moldable articles having modifiable displays. Plastic molding may generally refer to a process for making parts out of plastic (e.g. thermoplastic and thermosetting plastic) or other materials (e.g. metals, glasses, elastomers, and confections). Molding processes may include extrusion molding, injection molding, blow molding, thermoforming, rotational molding, casting, foaming, compression molding, transfer molding and other molding processes where a liquid or semi-liquid is formed into a shape and allowed to dry, cure, set or otherwise come to a non-flowing state. Thermoforming involves heating a plastic film or sheet to a pliable forming temperature, forming the sheet to a specific shape in a mold, and cutting the article to create a usable product. Many different products can be made via thermoforming, including cups, lids, and plates, for example.

In some embodiments, modifiable displays similar to the displays described above may be incorporated into molded products. Different types of plastic might be used including (but not limited) PET, PEN, or polycarbonate. The plastic films can be different thickness and have various properties such as protective layers. Displays capable of withstanding the temperatures and/or pressures associated with the molding process may be incorporated into the products.

Commercial display technologies, as previously mentioned, may include flexible LED, LCD, OLED, AM-OLED, EPD, or other display technologies. LCD displays typically require back lighting such as LEDs, so they may not be ideal for thin, flexible displays. EPD displays and OLED displays typically do not require backlighting. To date, there are no reports of displays integrated in plastic parts that have been molded. However, applicant has discovered that the combination of certain materials and processes can be used to make such parts. Traditionally, indium tin oxide (“ITO”) has been used as the transparent conductive film in LCD, EPD, and OLED displays. ITO is a ceramic, and due to its brittle nature, it does not perform well in a thermoforming process. Conductors made of carbon materials such as carbon nanotubes, however, perform much better in a molding process such as thermoforming. For example, a simple passive matrix EPD display with a top electrode comprised of a carbon nanotube (“CNT”) film and a bottom electrode comprised of a CNT film performs well in a thermoforming process and remains functional before and after the thermoforming process.

In keeping with the above, other embodiments of the present disclosure may include a process for making parts comprised of plastic that are molded and incorporate displays or modifiable displays. The process may include: (1) forming a stack comprised of a plastic substrate on the top and bottom, with a display between the two plastic substrates that is capable of surviving a thermoforming process; and (2) thermoforming the stack to form a desired shape and configuration In some embodiments, the stack may be formed, bent, curved, or otherwise shaped to conform to the surface profile of the desired molded product and a surface of the stack may be arranged to coincide with the surface of the molded product such that, after thermoforming, the display is arranged at or near the surface of the molded product and incorporated into the molded product.

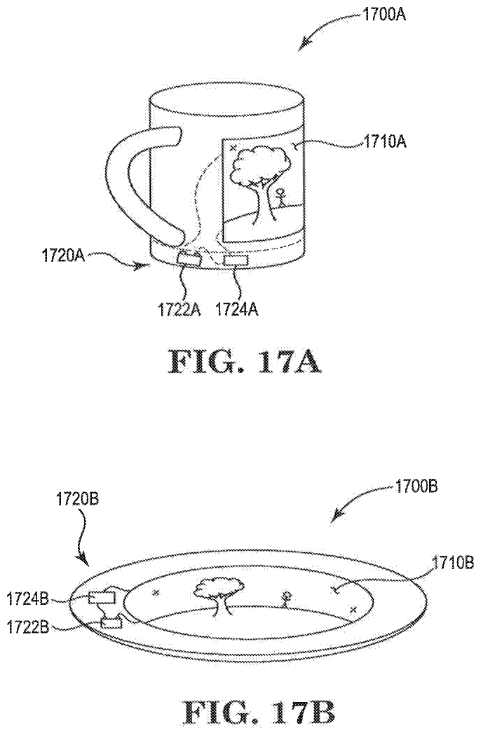

Turning now to FIGS. 17A and 17B, molded products 1700A, such as a plastic cup, and 1700B, such as a plastic plate, having modifiable displays are shown. The molded products 1700A/B may be constructed using the above described process in some embodiments. The plastic cup 1700A and plastic plate 1700B may each have any suitable shape and design elements, including and/or in addition to those shown in FIGS. 17A and 17B. For example, the plastic cup 1700A may be a handled mug as shown in FIG. 17A in some embodiments, or in other embodiments, may be a stemmed wine glass. The molded product 1700A/B may have an active element 1710A/B and a circuit 1720A/B.

The active element 1710A/B may be similar to any of the above described active elements. The active element 1710A/B may be or include one or more displays such as an LED, LCD, OLED, AM-OLED, EPD, or other modifiable display. In some embodiments, the active element 1710A/B may be a color changing conductor configured to change colors depending on the voltage applied to its surface. The active element 1710A/B may be a flexible display in some embodiments. The active element 1710A/B may be configured to display one or more colors, designs, images, series of images, videos, and/or other elements operatively chosen by a user. The active element 1710A/B may be configured to display a dynamic display in some embodiments. The active element 1710A/B may be positioned on or incorporated in a portion of the molded product 1700A/B. For example, the active element 1710A/B may be positioned over all or a portion of an upper or outer surface of the product 1700A/B. The active element 1710A/B may generally have any suitable size and shape. In some embodiments, a coating, film, or other flexible, transparent material may be positioned over the active element 1710 so as to protect the active element from scratches, water damage or other damage.

The circuit 1720A/B may be similar to circuits 120, 200, or any of the above described circuits. The circuit 1720A/B may generally be configured to power the active element 1710. The circuit 1720A/B may be positioned on, coupled to, or otherwise integrated with the molded product 1700A/B in various ways, such as positioned within a base portion of the cup 1700A or plate 1700B, for example. In some embodiments, the circuit 1700A/B may be removably attached to the molded product 1700A/B. The circuit 1720A/B may be rigid or flexible, and each element of the circuit may include a wide range of sophistication depending on the desired ability of adjustment. Similar to the circuits discussed above, the circuit 1720A/B may have a power supply 1722A/B configured to power the circuit and/or active element 1710 and a controller 1724A/B configured to send and/or receive instructions to operate the active element. In some embodiments, the controller 1724A may include sound capabilities and a speaker may be provided such that music and/or sound may be played by the cup molded product 1700A/B. In some embodiments, the power supply 1722A/B may be rechargeable, such that the molded product 1700A/B may have a port, plug, or other means for electrically coupling the power supply to a charging system.

Another embodiment of the present disclosure may include a plastic pen that is molded and incorporates a modifiable display. The circuitry in this embodiment may be arranged at or near the top of the pen, for example. In some embodiments, the circuitry of the pen may be rechargeable.

### Self-Expression Kit

In some embodiments, an article of the present disclosure having a modifiable display may be configured such that the display may be readily removable from the article. For example, a user may have the ability to remove a display from a backpack, handbag, or other article, and in some embodiments, attach the display to another surface. For example, magnets, clips, Velcro, suction cups, or other attachment mechanisms may be used, once the display is removed from the article, to couple the display to another surface, such as a car, refrigerator, locker, or other surface. In this way, users may be able to bring their self-expression to other surfaces, such as a refrigerator door in the kitchen, or a rear surface of a vehicle while driving. In some embodiments, the present disclosure relates to a kit or system for self-expression. For example, such a kit or system may include an article, such as a backpack or other wearable article for example, and a modifiable display, such as a flexible display, that may be removably attached to the article. The kit or system may include means for attaching the modifiable display to the article, such as Velcro, clips, magnets, or other attachment mechanisms. In some embodiments, the modifiable display may be arranged within a case, cover, or enclosure configured for protecting the display. For example, the modifiable display may be arranged in a thin, plastic sleeve, such as a transparent or at least partially transparent plastic sleeve. The case, cover, or enclosure may be rigid, semi-rigid, or flexible. The article may generally be configured to receive the modifiable display. For example, the article may have one or more attachment mechanisms configured to couple to the display. In some embodiments, the article may have one or more openings configured to receive and/or house components of the display. In other embodiments, the article may have a flexible or rigid case, cover, or enclosure configured to receive the display. For example, the article may have a thin, plastic sleeve, such as a transparent or at least partially transparent plastic sleeve, configured to receive the modifiable display. Additionally, in some embodiments, the self-expression kit or system may include one or more attachment mechanisms for attaching the modifiable display to other surfaces. For example, the kit or system may include one or more Velcro strips, one or more magnets, one or more suction cups, one or more clips, and/or other attachment mechanisms for providing a user with options for attaching the modifiable display to various surfaces.

### Application/Program and Social Media

In some embodiments, application software, such as a smartphone application for example, may be used to download or upload colors, images, videos, or other media to the modifiable displays. The application may further allow users to control other properties of the modifiable display, such as timing or other functions. In some embodiments, the application may allow users to create or customize images, videos, or other media for modifiable displays. Additionally or alternatively, the application may allow users to download or purchase images, videos, or other media to send to the modifiable displays.

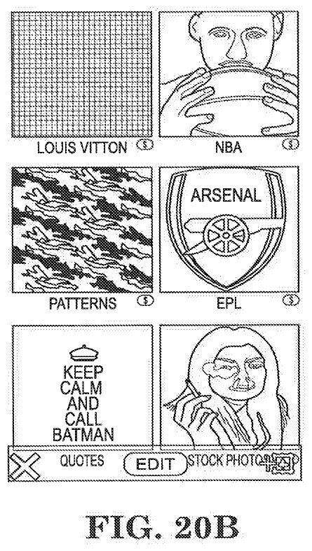

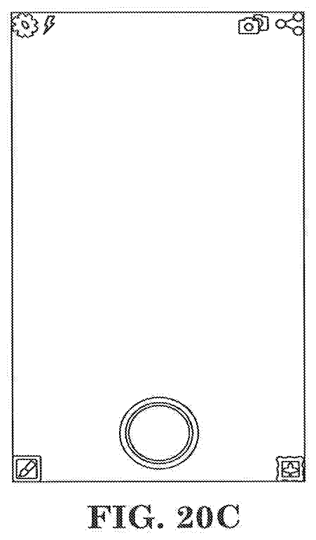

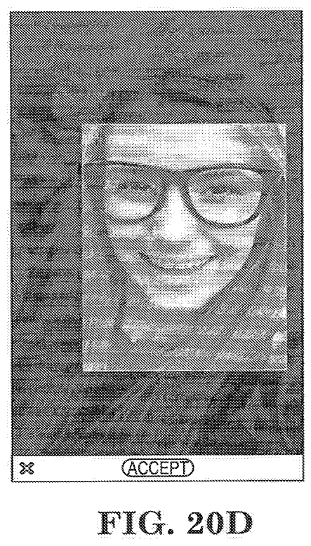

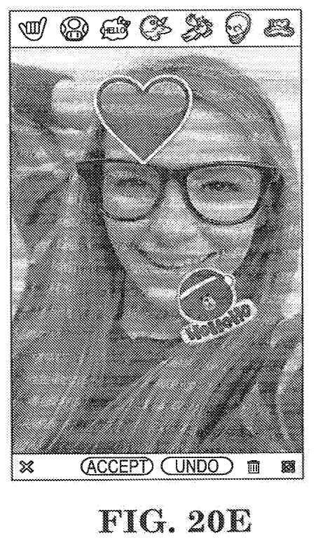

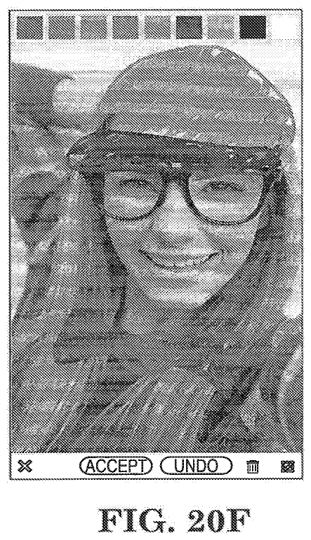

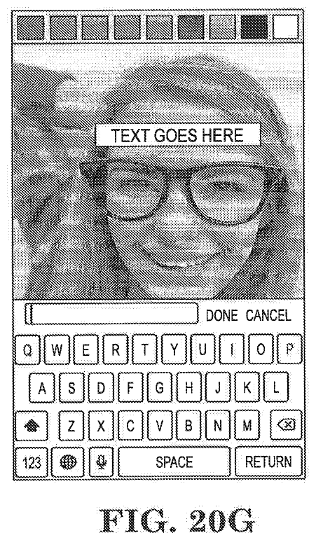

For example, FIGS. 20A-20G show some views of a smartphone (or other device) application for updating and/or communicating with a modifiable display of the present disclosure. The application may have various interfaces, screens, or pages from which a user may perform various actions. For example, as shown in FIGS. 20A and 20B, one interface, screen, or page may provide access to one or more libraries or databases of content that the user may select from for uploading to the user's modifiable display. Such content may include images, videos, colors, and/or other content. As shown in FIGS. 20A and 20B, in some embodiments, the content may be organized into folders or groups by, for example, different interests or types of content. In some embodiments, one or more folders or groups of content may access content stored locally on the user's device. For example, as shown in FIG. 20A, the My Stuff folder may allow a user to select a photo, video, or other content on the user's device for uploading the user's modifiable display. In some embodiments, users may have the option to edit or customize the selectable content. In some embodiments, the smartphone (or other device) application or other interface may initially have pre-loaded and/or freely available content to choose from, and users may have the option to search for and/or download additional images, videos, or other content. In some embodiments, at least some content may be available at a cost.

As shown in FIG. 20C, another interface, screen, or page of the smartphone application may access a camera capability of the smartphone or other device to allow a user to take a photo or video through the application. The user may then have the option of uploading the phone or video to the user's modifiable display. In some embodiments, a user may also have an option to “share” the photo or video from the application, such as to a social media platform. In some embodiments, a user may have options for editing the photo or video before sharing or uploading it. For example, as shown in FIG. 20D, a user may be able to crop or resize the photo. As shown in FIG. 20E, a user may have the option to place digital stickers or other content on the photo. As shown in FIG. 20F, a user may have the option to draw or color on the photo. Additionally, as shown in FIG. 20G, a user may have the option to place text on the photo. Video editing options may be provided as well.

Additional or alternative functionality may be provided in a smartphone (or other device) application, computer program, and/or other interface for updating and/or communicating with a modifiable display in other embodiments.

Additionally, in some embodiments of the present disclosure, a modifiable display item may be used in conjunction with one or more social media platforms. For example, the software applications described above may additionally have a social media component. The social media component may allow a user with a modifiable display device to electronically share or upload images, videos, or other elements that may also be displayed, or were previously displayed, on the user's modifiable display device. For example, where a user modifies his or her modifiable display article to display an image of a dog, the user may simultaneously update the social media component to also display the image of the dog. The social media component may additionally allow other users to view, comment on, like, favorite, share, or otherwise interact with images, videos, or other elements displayed on a user's modifiable display article. In some embodiments, the social media component may further sync with a user's modifiable display article. For example, when a user's image receives a comment on the social media component, the user's modifiable display item may update to display the comment. In some embodiments, the user may receive a notification and have an opportunity to approve the comment before it is displayed on the user's modifiable display article. Additionally or alternative to the social media component, modifiable display articles of the present disclosure may be configured to operate in conjunction with existing social media platforms, such as Facebook, Twitter, Instagram, Pinterest, Tumblr, Vine, and/or other current or future social media platforms.

In some embodiments, an individual may have the ability, through a smartphone application, social media platform, or other means, to upload an image, video, design, or other display to another individual's modifiable display. For example, a user or owner of a backpack of the present disclosure may have the ability to invite friends, such as through an application or social media platform, to design a display for his or her backpack. In some embodiments, once the friend designs a display, it may be automatically or manually displayed on the backpack owner's backpack. In some embodiments, the backpack owner may receive a notification and have an opportunity to approve the design before it is displayed on his or her modifiable display.

It may be appreciated that the articles of the present disclosure, particularly where combined with a social media platform, may provide an offline social media network, or an online to offline social media ecosystem wherein users may bring social media interactions into the offline world. That is, users may express themselves through digital media via a physical, tangible device, such as a backpack or other wearable article. Users may interact with one another by liking, favoriting, commenting on, or modifying each other's displayed media, and those interactions may also be displayed on the physical, tangible device.

Interaction with Modifiable Displays

In some embodiments, individuals may have the ability to interact with a modifiable display of the present disclosure in the physical world. That is, facial recognition technology, motion sensing, gesture recognition, 3D mapping technology, voice recognition, and/or other technologies may be used to allow individuals to interact with a modifiable display in a customized way. For example, in some embodiments, a user may select or design different images or media for display on his or her modifiable display, such as on a backpack display, for each of the user's friends. Facial recognition technology, through a camera incorporated into the backpack, may recognize when a particular friend is within viewing distance or otherwise nearby. The backpack may then display a particular image or other media associated with the particular friend. As a particular example, a user having a backpack with a modifiable display may, via an application or other program, configure the backpack to display a picture of the user's Friend A, along with a personal greeting, when Friend A is within viewing distance or otherwise recognized by the backpack. As the user wears the backpack, a camera and facial recognition technology incorporated into the backpack may determine when Friend A is within viewing distance or otherwise nearby. When the camera and recognition technology identify Friend A, the preselected image of Friend A and the personalized greeting may be displayed on the backpack for Friend A to view. In some embodiments, the image of Friend A may be displayed automatically or may provide the user with an option to display the image and message related to Friend A. The user may additionally program other media to be displayed for other friends or individuals, such that anytime the incorporated camera and facial recognition technology recognizes one of these individuals, an associated display may be presented. In some embodiments, the user may select one or more “default” images or displays that may be displayed when a friend-associated image is not otherwise being displayed.

Additionally or alternatively, in some embodiments, a modifiable display of the present disclosure may be configured to respond to physical gestures. For example, in some embodiments, an individual may interact with a modifiable display by giving a thumbs up, gesturing or pointing upward or downward, or swiping a hand or finger to the left or right, or any number of other hand gestures or motions performed without actually touching the modifiable display. The modifiable display may have or be in communication with a camera and gesture recognition or similar technology configured to recognize and distinguish the motions and gestures. Different gestures recognized by the camera and technology may perform different functions. For example, a physical thumbs up performed by an individual may cause an image displayed on a modifiable display to be “liked” or “favorited.” A physical swipe with a finger or hand to the left or right, for example, may cause an image displayed on a modifiable display to change. For example, a next image selected by a user may be displayed when a swipe is recognized. That is, a user may select a plurality of images to display, and an individual may be able to swipe or scroll through the plurality of images by physically swiping a hand or finger in front of a camera associated with the modifiable display. In other embodiments, one or more hand motions or gestures may cause one or more image filters to be applied to an image or other media displayed on a modifiable display. An image filter may include one or more predetermined settings or properties, such as one or more color settings, composition settings, light settings, and/or other settings. One example of a filter may be a “grayscale” filter. Another image filter may be a “sepia tone” filter, for example. A swipe to the left or right, for example, recognized by a camera and gesture recognition technology, may cause the color, composition, light, and/or other image settings or properties of a displayed image to change. Physical gestures made by a user or owner of a modifiable display device or other individuals may be recognized and cause various functions with respect to the modifiable display. For example, a user may have a backpack with a modifiable display. As the user wears the backpack, other individuals who view the backpack may be able to gesture to the backpack.

In some embodiments, gesture recognition technology may be combined with facial recognition technology. For example, where an individual makes a gesture, such as a thumbs up, to “like” or “favorite” a displayed image, in addition to recognizing the gesture, the individual making the gesture may also be recognized due to facial recognition technology associated with the modifiable display. In this way, the actual individual who liked or favorited the image may be associated with the digital “like” or “favorite.” For example, the individual's social media profile may be associated with a digital “like” or “favorite” of the image after that individual is recognized as gesturing a physical like or favorite of the image. As another example, an individual may make a particular gesture for uploading or downloading the displayed image. With facial recognition technology, the gesture may cause the displayed image to download or upload to the particular individual's social media profile or to cloud storage, for example.

In some embodiments, voice recognition technology may be used with respect to a modifiable display of the present disclosure. For example, users and/or other individuals may be able to activate various functions on a modifiable display by giving voice commands. A microphone and voice recognition technology may be incorporated into, or in communication with, a modifiable display. Voice commands may cause different images to be displayed, may cause images to be downloaded or uploaded, may cause filters to be applied to images, or may cause various social media platform operations, for example. In some embodiments, voice recognition may be capable of determining when commands are from particular individuals. For example, voice recognition incorporated with a modifiable display may determine particularly when a user or owner of the modifiable display is providing voice commands, such that only the user or owner may have the ability to provide particular commands. In other embodiments, voice recognition may be configured to recognize voice commands from other individuals, such as the user's friends. In this way, the modifiable display may be configured to respond to voice commands provided by one or more particular individuals.

### Sponsorship

As described above, an article of the present disclosure, such as a backpack or other wearable article, may be adapted to display a static or dynamic advertisement, promotional material, and/or content related to a particular product, company, or brand. For example, a user may select the advertising material and update the display via an application, such as a smartphone application in some embodiments. In other embodiments, the user may select the advertising material and update the display via a desktop or laptop computer, tablet computer, interface on the article itself, or other interface. The interface may communicate with the backpack or other article via a wired or wireless connection. In some embodiments, the user may set a predetermined time for the advertisement to be displayed, after which the display may automatically revert to a previously displayed or selected image or images.

In some embodiments, articles of the present disclosure may provide sponsorship opportunities for users of the articles and for advertisers. For example, a user of an article, such as a backpack or other wearable article, of the present disclosure, may form an agreement with an advertiser to operate as a sponsored user. In this way, the user may be compensated by the advertiser in exchange for displaying a particular advertisement, promotional material, or other content on the user's backpack or other article. The user may be compensated for displaying the advertisement for a particular period of time and/or at a particular location. As a particular example, a user may be compensated for displaying a particular advertisement on his or her backpack while wearing or carrying the backpack for at last one hour at a public location, such as a shopping mall. In other embodiments, the user may be compensated for displaying the advertisement for at least one hour each day over a period of five days, for example. Other sponsorship schemes, having differing timing, location, and other parameters, are contemplated by the present disclosure as well. A sponsorship agreement between an advertiser and a user may relate to a one-time act of displaying the advertisement or other material, a defined number of advertisement displays, a defined time for displaying advertisements, or may be an ongoing agreement.

In some embodiments, a network may be provided whereby advertisers and article users may connect. For example, the network may include a sponsorship marketplace wherein advertisers may list available sponsorship opportunities, users may list availability or preference for sponsorship opportunities, and/or through which advertisers and users may contact one another. In some embodiments, advertisers may select users based on age, gender, location, type of article having a display, or other parameters. In some embodiments, advertisers may select, find, and/or contact users based on tracked users interests or preferences. For example, the smartphone application, computer program, or other interface through which users select, upload, download, and/or purchase images to display on their articles may track the images or types of images that particular users choose. For example, where a user frequently displays and/or interacts with digital content related to sports, athletics, athletic gear, athletic brands, and/or the brand NIKE, this information may be tracked and made available to advertisers. Based on the tracked data, NIKE, ADIDAS, and similar advertisers may select the user as a potential sponsorship candidate. Similarly, as described above, the smartphone application or other interface may provide a social media element, wherein users may view, comment on, like, favorite, share, or otherwise interact with other users' displayed content. These actions may be tracked and may be available for advertisers additionally or alternatively, in order to help advertisers select appropriate sponsorship candidates. In some embodiments, users may give permission for content selections and/or other actions to be tracked and to be provided to advertisers. For example, in some embodiments, a user may register to be a sponsor, and in doing so, may agree to his or her activity being provided to advertisers such that advertisers may contact the user with particular sponsorship opportunities.

Once an advertiser and a user enter into a sponsorship agreement, the advertiser may have an ability to verify whether the user actually displays the advertisement as expected. For example, in some embodiments, the smartphone application or other interface through which the user uploads, downloads, or otherwise causes content to be displayed on the user's article may provide verification that the particular advertisement was displayed on the user's backpack or other article. In some embodiments, the actual Bluetooth transmission, or other wired or wireless transmission between the article and the smartphone or other device, may be verified. This verification information may be provided to the advertiser. This may allow an advertiser to ensure that a user has displayed the appropriate advertisement or other content as expected.

Additionally or alternatively, advertisers may verify display of the advertising material or other content on a user's article via one or more audio and/or visual devices. For example, as described above, a camera, microphone, or other audio and/or visual device may be incorporated into or coupled to the article and/or the display itself. Such audio and/or visual device(s) ay provide verification that the user displayed the advertisement or other content as expected. For example, a camera may be arranged near the display and may provide photographs and/or a video from the period of time during which the advertisement is expected to be displayed. Such photographs and/or video may provide an indication that the user did not attempt to cover or hide the displayed advertisement (i.e. by physically covering the backpack or other article with a cloth, or by placing the backpack or other article in a locker). Additionally, such photograph or video evidence may provide information related to the location where the user wore or carried the article with the displayed advertisement. For example, if the user agreed to carry or wear the article in a shopping mall, photographs and/or video may provide images during the user's time in the shopping mall to show that the user had the article in the expected location.

Additionally or alternatively, audio and/or video components may provide advertisers with consumer reactions to the advertising material or other content. That is, for example, a camera incorporated into the article or digital display may be used to record audio responses and/or visual responses of consumers who view the displayed advertisement. This may provide advertisers with some gauge as to how consumers respond to the particular advertisements. It may also provide advertisers with a count or a rough count of the number of consumers who viewed the advertisement. In some embodiments, body count technology may automatically count a number of consumers who saw or were exposed to the advertisement. In some embodiments, sponsored users may be compensated based on a number of consumers who saw and/or exhibited a response to the advertisement. In some embodiments, facial recognition or other recognition or mapping technology may be used to identify consumers or consumer actions or responses. For example, facial recognition technology may be used to identify individual consumers who viewed the advertisement or who exhibited, for example, a positive response to the advertisement. Advertisers may wish to provide targeted advertising and/or sponsorship opportunities to these consumers. The facial recognition technology may compare images captured by the video component with consumers' social media profiles and/or other databases to identify consumers. In some embodiments, recognition or mapping technology may be used to identify a consumer response. For example, where a consumer physically directs a “thumbs up” toward the displayed advertisement or in response to the displayed advertisement, this action may be recorded as a positive response. The physical thumbs up may trigger a digital “like,” “favorite,” or “follow” of the advertiser or related company or product. Other physical actions may trigger other digital actions or responses as well. In this way, physical offline actions may be transferred into digital online actions.

The audio and/or visual equipment described above may collect data at any suitable frequency and may provide the data via any suitable means. For example, in some embodiments, a video camera may provide a streamed live feed that may be transmitted to an advertiser. The live feed or recorded data may be initiated automatically when the user displays the advertising content or may be activated via the user, the advertiser, or by other suitable means. In other embodiments, the video and/or audio components may provide collected during the advertisement display, but that is not necessarily live Live or otherwise collected data may be collected and uploaded or downloaded to a storage device over a wired or wireless network. In some embodiments, the storage device may be a cloud storage device. In other embodiments, the storage device may be the user's smartphone or other device in some embodiments. In other embodiments, the storage device may be locally arranged on the backpack or other article. Other storage devices may be used as well. In some embodiments, the audio and/or visual data may stream to the user's mobile device or smartphone via a Bluetooth or Wi-Fi connection, for example, and may additionally upload or download to a cloud storage device via a Wi-Fi connection.

It may be appreciated that the described sponsorship network may, in some cases, operate to leverage an existing network of modifiable display devices. That is, many users may initially purchase modifiable display articles of the present disclosure, such as backpacks and other wearables, for purposes of self-expression and social interaction. Users may initially and/or principally use the articles to share content they like with friends and/or to interact with others. A sponsorship advertising network may build on that existing network of physical devices by providing the users with an opportunity to use their devices to make an income in exchange for displaying sponsored content. Moreover, due to targeted sponsorship opportunities based on tracked user activity, the user may be rewarded or compensated for displaying content that he or she already enjoys.

It may be appreciated that the displays employed in articles of the present disclosure may not necessarily be flexible displays in some embodiments. For example, some displays may employ glass, rigid plastic, or other rigid materials or semi-rigid materials.

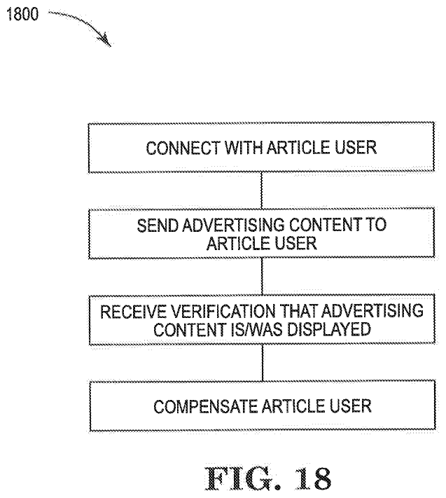

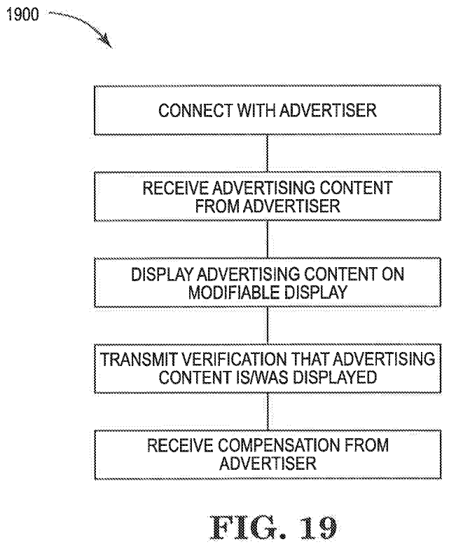

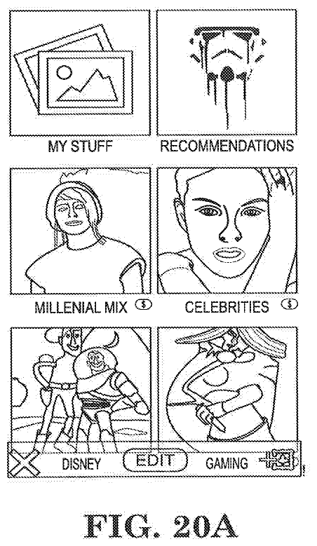

FIGS. 18 and 19 illustrate methods, according to some embodiments, of displaying advertising content to consumers. For example, looking first at FIG. 18, one method 18000 may relate to an advertiser's user of the sponsorship network or marketplace, and may include connecting with an article user, sending advertising content to the article user, receiving verification that the advertising content is or was displayed, and/or compensating the article user. Connecting with the article user may include advertising for an article user on the sponsorship network or marketplace, sending an invitation to, or accepting, an article user, and/or forming an agreement with an article user. In some embodiments, as described above, article users may be selected based on various parameters, including for example their likes, preferences, or interests. Sending advertising content to the article user may include sending static or dynamic media, configured to be displayed on the article user's modifiable display, in any suitable form. The media may be sent through an e-mail or text message, for example, or may be uploaded to a cloud storage device such that the article user can download the media. Receiving verification that the advertising content is or was displayed may include receiving one or more images, videos, and/or sound bites during, or after, display of the advertising content. In some embodiments, receiving verification may include receiving a confirmation of the user's transfer or selection of the content, thus showing that the user transferred the content to his or her modifiable display. In other embodiments, verification may include alternative or additional means. Moreover, compensating the article user may include providing any suitable means of compensation, such as monetary compensation, products, offers, or other means.

Turning to FIG. 19, another method 1900 may relate to an article user's use of the sponsorship network or marketplace, and may include connecting with an advertiser, receiving advertising content from the advertiser, displaying advertising content on the modifiable display, transmitting verification that the advertising content is or was displayed, and/or receiving compensation from the advertiser. Connecting with the advertiser may include, for example, requesting a sponsorship from the advertiser via the network or marketplace, answering an offer from the advertiser on the network or marketplace, and/or forming an agreement with the advertiser. Receiving advertising content from the advertiser may include receiving the content in any suitable form via any suitable means, as described above with respect to the method 1800. Displaying the advertising content may include downloading, uploading, or transferring the advertising content to the user's modifiable display on the user's article. In some embodiments, displaying the advertising content may include wearing the article if it is a wearable article or accessory, such as a backpack. Displaying the advertising content may additionally include bringing or wearing the article to a designated or suitable location at a designated or suitable time. As described above, verification of the display may be sent to the advertiser. In some cases, the article user may initiate transfer of verification, and in other cases, such transfer of verification may be automatic or at least partially automatic. Moreover, as described with respect to the method 1800, the article user may receive compensation from the advertiser by any suitable means and in any suitable form.

### Licensing

In light of the above series of displays, the content displayed on the modifiable displays may be subject to intellectual property rights such as copyright, trademark, and publicity rights. Moreover, unlike current downloading performed by individuals, the present series of products may implicate copyright rights relating to public performance and the like. In some embodiments, individuals may generate materials that can be copyrighted for use in modifiable display products. For example, individuals may upload pictures to an electronic vest, shirt, or other wearable item. Similarly, an individual might generate a unique design to upload to his/her electronic tie. Individuals utilizing electronic wear or other items may also seek to incorporate trademarked terms into their displays. For example, the owner of an electronic hat may seek to program the hat to say “Dodgers” when he attends a Dodgers baseball game, and then program the same hat to say “Lakers” when he attends a basketball game. Large corporations and brands generally own popular trademarks that people may seek to use in electronic display items. Finally, individuals may seek to incorporate pictures of individuals in their electronic wear, where rights of publicity may be implicated. For example, an individual with an electronic vest may wish to display a picture of a certain celebrity on the vest.

There is a need for a system for enabling holders of intellectual property rights to license their intellectual property rights and associated materials to third parties desiring to use the material in their own electronic wear. For example, if a person is wearing an electronic tie that is displaying a copyrighted design and another person wishes to use the same design in his/her own electronic tie, a system is needed for the latter person to obtain a license to use the copyrighted design.

In this way, one or more embodiments of the present disclosure may include a database for storing content that can be licensed for use is modifiable display items, such as clothing or other items. The database can include content subject to intellectual property protection supplied by brands, professional design firms, professional photographers, writers and poets, and ordinary individuals or users. In order for content to be registered in the database, the generator of the content may provide particular information and make particular representations and warranties regarding ownership and ability to license to third parties. Each piece of content may be assigned a specific electronic ID.

One or more additional embodiments of the preset disclosure may include systems and methods for enabling copyright holders to license their copyrights to third parties wishing to use the copyrights in similar electronic articles. The system may include an interface between the modifiable display item, devices such as computers or smartphones, and a website supported by a database on a server (or an “App” related to the database). An individual can visit the web site (or accompanying App) and obtain a legal license to the content as well as physical access to the content.

In at least one specific embodiment, the system may enable owners of content to selectively decide and negotiate the terms and conditions for licensing the content to third parties for use in electronic wear and/or products. For example, the owner of particular original content (for example, design or picture) subject to copyright protection may display the material in an electronic vest or an electronic tie. A third party may wish to utilize the design or picture for his or her own purposes, including (but not limited to), displaying the design or picture in her electronic wear. The third party can use her mobile device to communicate with the electronic wear to determine if the design or image has been registered in the system. That is, the electronic wear may store an indication of registration in the system and may further include a web address to direct the third party if the copyright is registered. In other embodiments, the electronic wear may store an ID and the third party mobile device may communicate with the electronic wear of the copyright owner or other wearer to access the ID and may, in turn, communicate with the database via the website to determine if the copyright is registered in the system. If the copyrighted content has been registered in the system, the third party may be directed to a web site or mobile interface that enables the third party to either: (1) pay for a license if license terms have already been set; or (2) make an electronic offer to the copyright holder to obtain a license. The copyright holder may be alerted (via text message, email, or other mechanism) that a third party has licensed or is making an offer to license the copyrighted content. If the copyrighted material has not been registered in the system, the system will notify the person wearing the electronic wear that a third party is interested in licensing the material. The system may inform the person wearing the electronic wear that, if he wishes to license the material, he must register the material as copyrighted material in the system. If a deal is formed for the copyright, the content may also be downloaded from the system.

In other embodiments, the owners of content may agree to a standardized set of terms and conditions to register their content in the database for licensing to third parties. For example, each owner may agree to license each unique set of content for $1.00 to third parties that wish to license and download the content. In still other embodiments, some copyright owners may actively negotiate prices for their copyright while other owners agree to a set price for content. In some embodiments, agreeing to a set price may include agreeing to varying set prices depending on the content being provided. For example, more prominent Trademarks or Copyrights may agree to a higher set price than lesser known Trademarks or Copyrights, for example. In still other embodiment an algorithm may be provided to increase the price of the content as the demand for the content increases. In some embodiments, the increasing price may trail the demand slightly to avoid over pricing the content. Still other embodiments may be provided for pricing and/or negotiating content costs.

### Additional Considerations

Various embodiments of the present disclosure have been described as articles or products having modifiable displays, including flexible displays. It may be appreciated that any articles, products, or embodiments of the present disclosure may include any or all of the elements described with respect to any of the articles, products, or embodiments described herein. It may further be appreciated that in various embodiments of the present disclosure, the modifiable displays may be configured to display one or more colors, patterns, images, series of images, videos, and/or other elements. Generally, a user may have the ability to select what is to be displayed on a modifiable display. The selection may be done using any suitable means. For example, a user may use a switch or other device coupled to the controller in order to select between one or more available colors, images, or other displays. In other embodiments, a device such as a computer, tablet, smartphone, or other device may be used to select one or more available colors, images, or other displays. The computer, tablet, smartphone, or other device may communicate with the controller via a wired or wireless connection. The available colors, images, or other displays may be selected from a predetermined list, downloaded, uploaded, created, or otherwise obtained from any suitable source.

In some embodiments, an article of the present disclosure may have a tracking device, which may allow a user to view a GPS location of the article. For example, the article may include a GPS receiver and means of transmitting GPS coordinates. Other tracking devices may include GSM capabilities and/or a Bluetooth beacon. In some embodiments, for example, a backpack of the present disclosure may have a tracking device. The tracking device may allow a parent to track the location of his or her child based on the tracked location of the backpack, for example.

In some embodiments, an article of the present disclosure having a modifiable display may have one or more integrated speakers or other sound emitting devices. That is, for example, where a user uploads or downloads a video to his or her modifiable display, sound accompanying the video may be emitted from the device while the video plays. Similarly, a user may upload or download a song or other sounds to his or her article, such as to accompany one or more images or designs displayed on the modifiable display.

In some embodiments, a modifiable display of the present disclosure may function as a monitor for a phone or other device connected thereto with a wired or wireless connection. The phone or other device may be used to access a Facebook or other social media account and thus display social media content on the modifiable display. For example, a user may have a backpack of the present disclosure having a modifiable display, and may be able to display on the backpack pictures, videos, or other content from the user's Facebook page. Additionally or alternatively, an article of the present disclosure having a modifiable display may have WiFi capabilities and may be configured to scan for and/or connect with a wireless network in order to access to the Internet to show and/or stream content. In still other embodiments, an article of the present disclosure having a modifiable display may have its own mobile network communication, such as a mobile phone network interface, and the display may use that network to access and/or display data. In some embodiments, a modifiable display, such as a display on a backpack for example, may function as a computer screen, and may have its own dedicated processor and/or inputs, such as a keyboard, mouse, or other inputs. In some embodiments, the modifiable display may be removable.

The content of each of the following patent applications is hereby incorporated by reference herein in its entirety: U.S. Provisional Patent Application No. 61/702,715, entitled “Electronic Wear and Systems and Methods for Licensing Intellectual Property Used in Electronic Wear,” and filed Sep. 18, 2012; U.S. Provisional Patent Application No. 61/730,758, entitled “Molded Plastic Parts Incorporating Displays,” and filed Nov. 28, 2012; U.S. Provisional Patent Application No. 61/731,019, entitled “Wallet Comprising a Display Capable of Elongation,” and filed Nov. 29, 2012; U.S. Provisional Patent Application No. 61/739,121, entitled “Electronic Stickers,” and filed Dec. 19, 2012; U.S. Provisional Patent Application No. 62/001,950, entitled “Modifiable Display Devices and Systems,” and filed May 22, 2014; U.S. Provisional Patent Application No. 62/025,582, entitled “Electronically Programmable Cap,” and filed Aug. 17, 2014; U.S. patent application Ser. No. 14/429,054, entitled “Modifiable Display Devices and Systems,” and filed Mar. 18, 2015; and U.S. Provisional Patent Application No. 62/305,745, entitled “Modifiable Display Devices and Systems,” and filed Mar. 9, 2016.

For purposes of this disclosure, any system described herein, for example the licensing system or the several systems of wearable displays and/or molded product displays, may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A system for modifying a display in response to non-touching interaction with the system, the system comprising:
a system power supply;
a controller in operative communication with the power supply and comprising:
a processor adapted to execute programmed instructions; and
a computer readable storage memory device in operative communication with the processor, the memory configured to store data and the programmed instructions;
a display in operative communication with the system power supply and controller; and
a camera comprising a battery power supply and/or in operative communication with the system power supply and in further operative communication with the controller, wherein the camera is adapted to obtain images of faces and/or physical gestures without touching interaction and transmit the obtained images to the controller;
wherein the controller is adapted to recognize the images transmitted by the camera and, in response to a recognized image, modify the display in accordance with the programmed instructions.

2. The system of claim 1, wherein the display is a flexible display.

3. The system of claim 2, wherein the flexible display consists of at one of the group consisting of an: LED display; LCD display, OLED display, AM-OLED display, and EPD display.

4. The system of claim 1, wherein the display is configured to display at least one of the group consisting of: a color, an image, and a video.

5. The system of claim 1, wherein the system is operatively attached to, or integrated with, at least one of the group consisting of: a backpack, a notebook, and a sticker.

6. The system of claim 1, wherein the controller is adapted to recognize the images transmitted by the camera and, in response to a recognized image indicating that a particular individual is within viewing distance, modify the display in accordance with the programmed instructions.

7. The system of claim 6, wherein the programmed instructions comprise instructions to modify the display by displaying at least one of the group consisting of: a message, an image, and a video associated with the particular individual.

8. The system of claim 7, wherein the at least one of the displayed message, image, and video comprises an advertisement associated with the particular individual.

9. The system of claim 6, wherein the programmed instructions comprise instructions to associate a physical gesture represented by one or more of the images transmitted by the camera with the particular individual.

10. The system of claim 1, further comprising the controller remotely located away from the camera.

11. A system for modifying a display in response to non-touching recognition by the system that a particular individual is within viewing distance and recognized using facial recognition, the system comprising:
a system power supply;
a controller in operative communication with the power supply and comprising:
a processor adapted to execute programmed instructions; and
a computer readable storage memory device in operative communication with the processor, the memory configured to store data and the programmed instructions;
a display in operative communication with the system power supply and controller; and
a camera comprising a battery power supply and/or in operative communication with the system power supply and in further operative communication with the controller, wherein the camera is adapted to obtain facial images without touching interaction and transmit the obtained facial images to the controller;
wherein the controller is adapted to recognize the images transmitted by the camera and, in response to a recognized image indicating that a particular individual is within viewing distance, modify the display in accordance with the programmed instructions.

12. The system of claim 11, wherein display is a flexible display.

13. The system of claim 12, wherein the flexible display consists of at one of the group consisting of an: LED display; LCD display, OLED display, AM-OLED display, and EPD display.

14. The system of claim 11, wherein the display is configured to display at least one of the group consisting of: a color, an image, and a video.

15. The system of claim 11, wherein the system is operatively attached to, or integrated with, at least one of the group consisting of: a backpack, a notebook, and a sticker.

16. The system of claim 11, wherein the controller is located remotely away from the camera.

17. The system of claim 11, wherein the programmed instructions comprise instructions to modify the display by displaying at least one of the group consisting of: a message, an image, and a video associated with the particular individual.

18. The system of claim 17, wherein the at least one of the displayed message, image, and video comprises an advertisement associated with the particular individual.

19. The system of claim 12, wherein the programmed instructions comprise instructions to associate a physical gesture represented by one or more of the images transmitted by the camera with the particular individual.

20. The system of claim 12, wherein the controller comprises at least one communication input and at least one communication output adapted for communicating with one or more external devices.
